(19) United States
(12) Patent Application Publication
(10) Pub. No.: US 2010/0272448 A1
(43) Pub. Date: Oct. 28, 2010

(54) OPTICAL BURST SIGNAL RECEIVING DEVICE

(75) Inventor: Tatsuo Kubo, Kohtoh-ku (JP)

Correspondence Address: SUGHRUE MION, PLLC, 2100 PENNSYLVANIA AVENUE, N.W., SUITE 800, WASHINGTON, DC, 20037, US

(73) Assignee: FUJIKURA LTD., Kohtoh-ku, Tokyo (JP)

(21) Appl. No.: 12/743,345

(22) PCT Filed: Nov. 19, 2008
(86) PCT No.: PCT/JP2008/071013

§ 371 Date: May 17, 2010

(30) Foreign Application Priority Data
Nov. 19, 2007 (JP) 2007-299602
Mar. 26, 2008 (JP) 2008-079729

(51) Int. Cl. H04B 10/06

(52) U.S. Cl. 398/202

(57) ABSTRACT

An optical burst signal receiving device includes: a photoelectric conversion unit that photoelectrically converts an input optical burst signal into a current burst signal and outputs the current burst signal; a transimpedance amplifier that converts the current burst signal output from the photoelectric conversion unit into a phase-inverted voltage burst signal; an equalizing amplifier that performs equalizing amplification on the output signal from the transimpedance amplifier and then outputs the resulting signal; a level detection circuit that detects the level of the output signal from the transimpedance amplifier; and an automatic gain control circuit that controls at least one of the transimpedance amplifier and the equalizing amplifier such that the optimum gain is attained for the level of a burst cell detected by the level detection circuit, in which the level detection circuit has: a monitor window generating unit that generates a monitor window signal that regulates a level detection block, which is a predetermined period commencing from the start point of a preamble portion of the burst cell; a reference voltage generating circuit that generates a reference voltage signal; a threshold value comparator that compares the level of the output signal from the transimpedance amplifier with the level of the reference voltage signal; and an AND circuit that performs an AND operation on the monitor window signal output from the monitor window generating unit and the output from the threshold value comparator.

### TECHNICAL FIELD

The present invention relates to an optical burst signal receiving device that is used to receive optical burst signals transmitted from a subscriber in a station in an optical network, and, more specifically, to technology that is used to adjust the signal levels of burst signals received from each one of a plurality of subscribers such that these levels are substantially uniform.

Priority is claimed on Japanese Patent Application No. 2007-299602, filed Nov. 19, 2007, and on Japanese Patent Application No. 2008-079729, filed Mar. 26, 2008, the contents of which are incorporated herein by reference.

### BACKGROUND ART

Conventionally, one type of optical communication network (called “Single star”) is known in which a station-side communication device is connected to each one of a plurality of subscriber-side communication devices respectively via individual optical fibers. According to this type of network structure, it is necessary for an optical fiber to be laid for each subscriber. In contrast to this, another type of optical communication network (called a “Passive optical network” (PON)) is known in which a single trunk optical fiber is shared by a plurality of subscribers. PON is widely used in optical communication services typified by FTTH (Fiber to the home), FTTB/C (Fiber to the building/curb), FTTCab (Fiber to the cabinet), and the like.

A conceptual view of a PON communication system is shown in FIG. 21. As is shown in FIG. 21, a trunk optical fiber 820 and branch optical fibers 840 that are split off from the trunk optical fiber by an optical splitter (also known as an optical coupler) 830 are laid as optical communication paths between a station-side communication device 810 and subscribers U1, U2, . . . , Un. As a result, the single trunk optical fiber 820 is shared by a plurality of subscribers.

As terminal devices of the optical communication paths formed by the trunk optical fiber 820 and the branch optical fibers 840, OLT (Optical line terminals) 813 are provided in the station-side communication device 810, and ONU (Optical network units) 850 are provided on the subscriber side. The station-side communication device 810 is provided, in addition to the OLT 813, with a router 811 and a switch 812. The OLT 813 are connected to the router 811 via the switch 812, and this router 811 is connected to the Internet 800. As a result, each of the subscribers U1, U2, . . . , Un is connected to the station-side communication device 810 via the branch optical fiber 840 and the trunk optical fiber 820, and is able to access the Internet 800 via this communication device 810.

Various types of PON communication systems exist such as ATM (Asynchronous transfer mode)—PON systems, B (Broadband)—PON systems, and E (Ethernet (Registered Trademark))—PON systems. Optical signals received by the station-side OLT 813 from the subscriber-side ONU 850 are, in the majority of cases, optical burst signals formed by an optical pulse train. The OLT 813 functions as an optical burst signal receiving device that receive these optical burst signals and output them as electrical signals.

Hereinafter, an OLT will be described as an optical burst signal receiving device.

Generally, because individual differences exist between optical communication paths which include the branch optical fibers 840 laid to the homes of each subscriber, the signal levels (i.e., signal strengths) of optical burst signals received by the station-side optical burst signal receiving devices (OLT) 813 differ for each subscriber, and a wide dynamic range is needed in the burst signal reproduction function. Because of this, the optical burst signal receiving devices (OLT) 813 are provided with a function of adjusting the signal levels of the electrical burst signals obtained from the optical burst signals received from each subscriber such that these signal levels are substantially uniform.

Hereinafter, when the simple term “burst signal” is used, it should be assumed that this refers to electrical burst signals (i.e., current signals or voltage signals).

Conventionally, a burst-by-burst AGC (Auto gain control) method is used in order to adjust the signal levels of burst signals on the station side such that they are substantially uniform (see Patent Document 1).

The typical schematic structure of a conventional optical burst signal receiving device provided with a burst-by-burst AGC function is shown in FIG. 22. In FIG. 22, an optical burst signal receiving device is formed by a photoreceptor element 901 that photoelectrically converts optical burst signals into current burst signals and outputs the result, a transimpedance amplifier 902 that converts the current burst signals into voltage burst signals, a level detection circuit 903 that detects output levels from the transimpedance amplifier 902, an automatic gain control circuit 904 that, based on detection results from the level detection circuit 903, optimizes at least one of the gain and phase of at least one of the transimpedance amplifier 902 and an equalizing amplifier 905, and the equalizing amplifier 905 that performs equalizing amplification on the voltage burst signals output from the transimpedance amplifier 902 and outputs these as electrical burst signals having a substantially uniform level.

The voltage burst signals which are output from the transimpedance amplifier 902 are input into the level detection circuit 903. A burst signal reset, which is a reset signal that initializes the level detection circuit 903, is also input into the level detection circuit 903 prior to the respective burst cells being input therein. The level detection circuit 903 is reset to an initial state each time a burst signal reset is input, and then detects the output level from the transimpedance amplifier 902.

The automatic gain control circuit 904 switches at least one of the gain and phase of at least one of the transimpedance amplifier 902 and the equalizing amplifier 905 based on the detection results from the level detection circuit 903, and controls the signal level of each burst cell output from the equalizing amplifier 905 such that these signal levels are substantially uniform.

The equalizing amplifier 905 performs equalizing amplification on the voltage burst signals output from the transimpedance amplifier 902, and outputs these as electrical burst signals having a substantially uniform level.

Here, the term “burst-by-burst” refers to the detection of the level of the output from the transimpedance amplifier 902 being performed for each burst cell as shown in waveforms (a) and (b) of FIG. 24.

The burst signal reset, which is a reset signal that initializes the level detection circuit 903, is output from the optical burst signal receiving device side prior to the respective burst cells being input into the level detection circuit 903. As a result of the level detection circuit 903 being initialized each time the reset signal is input therein, it is possible to perform the level detection for each burst cell.

A function in which the burst cell signal level is detected for each burst cell and at least one of the gain and phase of an amplifier system is adjusted such that the mutually different signal levels of burst cells that are received by the station-side optical burst signal receiving devices (OLT) 813 become substantially uniform in this manner, is called a burst-by-burst AGC function.

Next, specific structural examples of principal portions of the conventional optical burst signal receiving device shown in FIG. 22 are shown in FIG. 23, with operation waveforms of each section thereof shown respectively in waveforms (a) to (d) of FIG. 25.

In FIG. 23, the transimpedance amplifier 902 is formed by an amplifier 902a and a feedback resistor 902b connected to input and output terminals of the amplifier 902a.

The level detector 903 has a reference voltage generating circuit 903A, a comparator 903B, and a flip-flop circuit 903C.

When an output signal from the transimpedance amplifier 902 and a reference voltage signal from the reference voltage generating circuit 903A are input into the comparator 903B (the waveform (a) of FIG. 25), a magnitude comparison is made between the output signal from the transimpedance amplifier 902 and the reference voltage signal.

If the level of the output signal from the transimpedance amplifier 902 exceeds the level of the reference voltage signal, a signal (the waveform (c) of FIG. 25), which is obtained by inverting the output signal from the transimpedance amplifier 902 within a period exceeding the level of the reference voltage signal, is input from the comparator 903B into a set terminal of the flip-flop circuit 903C.

The flip-flop circuit 903C outputs to an output terminal 911 a pulse (the waveform (d) of FIG. 25) that rises at the timing of the rise of the output signal from the comparator 903B and falls at the timing of the rise of the burst signal reset (the waveform (b) of FIG. 25) which is a reset signal input from a reset terminal 910.

The pulse signal output from this flip-flop circuit 903C is a signal which is output when the signal level of the burst cells exceeds the signal level of the reference voltage signal output from the reference voltage generating circuit 903A. As a result of the automatic gain control circuit 904 adjusting at least one of the gain and phase of at least one of the transimpedance amplifier 902 and the equalizing amplifier 905 using this signal, the burst-by-burst AGC function is achieved.

Optical burst signal receiving devices provided with the above described type of burst-by-burst AGC function are commonly used.

[Patent Document 1] Japanese Unexamined Patent Application, First Publication No. H11-355218

### DISCLOSURE OF THE INVENTION

### Problems to be Solved by the Invention

Firstly, burst signals received by the optical burst signal receiving device will be described.

As is shown in the waveform (a) of FIG. 24, a burst signal is a signal in which burst cells having mutually different levels are mixed together. As is shown in FIG. 26, each burst cell is formed by a prebias portion, a preamble portion, and a payload portion.

The prebias portion is a signal portion generated by a prebias supplied to a user-side laser when an optical burst signal is being generated. The preamble portion has a signal pattern used for performing synchronization of the burst signal, on which equalization amplification has been performed by the optical burst signal receiving device, with an external clock by means of CDR (clock data recovery). The payload portion, principally, is a transmitted data portion. The length and timing of each portion of a burst cell are standardized by ITU-T, IEEE and the like.

Next, problems in optical burst signal receiving devices which are provided with the above described burst-by-burst AGC function will be described. Problems in optical burst signal receiving devices which are provided with the burst-by-burst AGC function are generated when the level of the reference voltage signal, which corresponds to the threshold value of the level detection circuit, matches the level of the output signal from the transimpedance amplifier. This state is described below with reference made to waveforms (a) to (e) of FIG. 27.

The waveform (a) of FIG. 27 shows a waveform of an optical burst signal input into the photoreceptor element 901. In this optical burst signal, the burst cell 1 has a high power level, while the power level of the next burst cell 2 is low.

When this optical burst signal is input into the photoreceptor element 901, it is photoelectrically converted into a voltage burst signal by the photoreceptor element 901 and the voltage burst signal is output from the transimpedance amplifier 902.

This burst signal is inverted and is then input into one input terminal of the comparator 903B (the waveform (b) of FIG. 27). In addition, the reference voltage signal output from the reference voltage generating circuit 903A is input into another input terminal of the comparator 903B.

As is shown in the waveform (b) of FIG. 27, if the signal level of the burst cell 1 exceeds the level of the reference voltage signal, while the signal level of the burst cell 2 does not exceed the level of the reference voltage signal, then only the signal of the burst cell 1, which exceeds the level of the reference voltage signal, is output from the comparator 903B, and the signal of the burst cell 2, which does not exceed the level of the reference voltage signal, is not output (the waveform (c) of FIG. 27).

Here, as is shown in the burst cell 2 in the waveform (d) of FIG. 27, there are cases where the level of the output signal from the transimpedance amplifier 902 substantially matches the output level of the reference voltage signal from the reference voltage generating circuit 903A. For example, in the waveform (d) of FIG. 27, although the signal level of the burst cell 1 of the burst signal exceeds the level of the reference voltage signal output from the reference voltage generating circuit 903A, the signal level of the burst cell 2 substantially matches the level of the reference voltage signal.

In this case, normal reproduction is obtained from the comparator 903B for the burst cell 1, however, for the burst cell 2, it is not possible to ascertain where the timing of the rise of the output signal from the comparator 903B (namely, the start point of the output pulses from the comparator 903B) is located in the preamble portion or the payload portion of the burst cell 2 (the waveform (e) of FIG. 27).

As a result, the start point of the output pulse from the flip-flop circuit 903C shown in FIG. 23 is generated from a contingent location. Because the gain and phase control performed by the automatic gain control circuit 904 is performed using the pulse signal output from the flip-flop circuit 903C, when the burst cell 2 signal level substantially matches the reference voltage signal level, there is a possibility that the gain and phase of the transimpedance amplifier 902 and equalizing amplifier 905 will change in the rear portion of the preamble portion or in the payload portion.

Here, when the gain and phase of the amplifier system are controlled in the optical burst signal receiving device that is provided with the burst-by-burst AGC function, it is necessary for the gain and phase to be switched at a timing that is as close as possible to the start point of the preamble portion in the burst cell. The reason for this is that, because the amplitude of a signal changes immediately after the gain and phase have been switched, if the gain and phase are switched in the payload portion in which data is stored or in the rear portion of the preamble portion used for performing synchronization of the signal with an external clock by means of CDR, there is a possibility that normal signal reproduction will not be possible.

In a conventional optical burst signal receiving device that is provided with the burst-by-burst AGC function, the switching of the gain of the burst signal has often been performed at a contingent timing in the burst cell. Because of this, there is a possibility that bit errors will be generated in the reproduced data.

The present invention was conceived in view of the above-described circumstances, and it is an object thereof to provide an optical burst signal receiving device which is provided with a burst-by-burst AGC function that prevents bit errors being generated in reproduced data as a result of the gain being switched.

### Means for Solving the Problems

An optical burst signal receiving device according to a first aspect of the present invention includes: a photoelectric conversion unit that photoelectrically converts an input optical burst signal into a current burst signal and outputs the current burst signal; a transimpedance amplifier that converts the current burst signal output from the photoelectric conversion unit into a phase-inverted voltage burst signal; an equalizing amplifier that performs equalizing amplification on the output signal from the transimpedance amplifier and then outputs the resulting signal; a level detection circuit that detects the level of the output signal from the transimpedance amplifier; and an automatic gain control circuit that controls at least one of the transimpedance amplifier and the equalizing amplifier such that the optimum gain is attained for the level of a burst cell detected by the level detection circuit, in which the level detection circuit has: a monitor window generating unit that generates a monitor window signal that regulates a level detection block, which is a predetermined period commencing from the start point of a preamble portion of the burst cell; a reference voltage generating circuit that generates a reference voltage signal; a threshold value comparator that compares the level of the output signal from the transimpedance amplifier with the level of the reference voltage signal; and an AND circuit that performs an AND operation on the monitor window signal output from the monitor window generating unit and the output from the threshold value comparator.

In the optical burst signal receiving device of the present invention which has the above described structure, the monitor window generating unit of the level detection circuit generates a monitor window signal that regulates a level detection block which is a predetermined period commencing from the start point of the preamble portion of the burst cell.

Meanwhile, the level of the output signal from the transimpedance amplifier and the level of the reference voltage signal generated by the reference voltage generating circuit are compared by the threshold value comparator circuit.

By setting the threshold value level which provides a reference for the comparison performed by the threshold value comparator (i.e., the level of the reference voltage signal) to the level of the voltage burst signal desired to be detected, the threshold value comparator only outputs burst signals that exceed that level.

By performing an AND operation on the monitor window signal output from the monitor window generating unit and the output from the threshold value comparator using the AND circuit, level detection is performed only within the level detection block which is a predetermined period commencing from the start point of the preamble portion of the burst cell that is regulated by the monitor window signal.

At this time, the gain of the transimpedance amplifier is switched by the automatic gain control circuit based on the output from the threshold value comparator only if an output signal is output from the threshold value comparator within the level detection block that is regulated by the monitor window signal. Namely, the switching of the gain of the transimpedance amplifier by the automatic gain control circuit is performed without exception at the leading end portion of the preamble portion of a burst cell (namely, within the level detection block).

In other words, level detection is not performed in areas outside the level detection block regulated by the monitor window signal and, therefore, the switching of the gain of the transimpedance amplifier by the automatic gain control circuit is not performed.

Accordingly, by controlling the detection time for the level detection of a burst cell in order for burst-by-burst AGC to be performed, the timing of switching the gain in burst-by-burst AGC can be limited to a predetermined period commencing from the start point of the preamble portion of the burst cell. As a result, normal signal reproduction in which there is no occurrence of bit errors is possible.

Moreover, by making it possible to set the timing of switching the gain in burst-by-burst AGC to within the leading end portion of the preamble portion of a burst cell, it is possible to reduce non-reproducible signal patterns in the preamble portion to a minimum, and achieve improved transmission efficiency.

Moreover, in the optical burst signal receiving device of the present invention, it is preferable for the monitor window generating unit to have: a comparator that compares the level of the output signal from the transimpedance amplifier with the level of a monitor window threshold value signal which provides a reference that is used to generate the monitor window signal; a flip-flop circuit that operates using the output from the comparator as a set signal, and using a burst signal reset that is output at a temporally earlier timing than the burst cell as a reset signal; a rise detection circuit that outputs a pulse signal at the timing when an output signal from the flip-flop circuit rises; and a pulse width extension circuit that outputs as the monitor window signal a signal obtained by extending the pulse width of the pulse signal output from the rise detection circuit by the block of the monitor window that regulates the level detection block of the burst cell, and

the difference between the level of the monitor window threshold value signal and the level of the output signal from the transimpedance amplifier at the time when the burst cell is not input, is smaller than the difference between the level of the reference voltage signal and the level of the output signal from the transimpedance amplifier at the time when the burst cell is not input.

In the optical burst signal receiving device of the present invention which has the above described structure, the comparator of the monitor window generating unit compares the level of the output signal from the transimpedance amplifier with the level of the monitor window threshold value signal which provides a reference for generating the monitor window signal. If the level of the output signal from the transimpedance amplifier exceeds the level of the monitor window threshold value signal, a pulse train signal that corresponds to the output signal (i.e., a pulse train signal) from the transimpedance amplifier is output.

Next, a signal that rises at the leading end portion of each burst cell and that is made to fall by the burst reset signal is output from the flip-flop circuit that operates using the output from the comparator as a set signal, and using the burst signal reset which is output at a temporally earlier timing than the burst cell as a reset signal. The signal output from this flip-flop circuit is a signal that rises at the timing when the pulse signal at the leading end portion of each burst cell is output from the transimpedance amplifier, and that falls at the timing when the burst signal reset is output.

Furthermore, the rise detection circuit outputs a pulse signal at the rise timing of the output signal from the flip-flop circuit. Namely, a pulse signal that rises at the rise timing of the pulse signal in the leading end portion of each burst cell is output.

Next, the pulse width extension circuit outputs as a monitor window signal a signal obtained by extending the pulse width of the pulse signal output from the rise detection circuit by the amount of the block of the monitor window which regulates the level detection block of a burst cell.

Level detection of the burst signal output from the transimpedance amplifier is thus performed within the block of monitor window generated, and the switching of the gain is performed by the automatic gain control circuit.

By controlling the detection time for the level detection of a burst cell in order for burst-by-burst AGC to be performed in this manner, the timing of switching the gain in burst-by-burst AGC can be limited to a predetermined period commencing from the start point of the preamble portion of the burst cell. As a result, normal signal reproduction in which there is no occurrence of bit errors is possible.

Moreover, by making it possible to set the timing of switching the gain in burst-by-burst AGC to within the leading end portion of the preamble portion of a burst cell, it is possible to reduce non-reproducible signal patterns in the preamble portion to a minimum, and achieve improved transmission efficiency.

An optical burst signal receiving device according to a second aspect of the present invention is an optical burst signal receiving device for a PON communication system that photoelectrically converts an input optical burst signal into a current burst signal and outputs the current burst signal, converts the current burst signal into a phase-inverted voltage burst signal, detects the level of a burst cell for each one of a plurality of burst cells contained in the voltage burst signal, and, based on the detection results, controls at least one of the gain and phase of an amplifier system such that the levels of the plurality of burst cells are substantially equal, in which the optical burst signal receiving device has a control unit that, based on the voltage burst signal, performs control for each one of the plurality of burst cells contained in the voltage burst signal such that the level detection operation is ended within a predetermined period commencing from the start point of a preamble portion of the burst cell.

In the optical burst signal receiving device of the present invention which has the above described structure, based on a voltage burst signal obtained from a signal that is created by photoelectrically converting a received optical burst signal, control is performed for each burst cell of the plurality of burst cells contained in the voltage burst signal such that the detection operation of the level detection of a burst cell, which is necessary for controlling at least one of the gain and the phase of the amplifier system such that the level of each burst cell is substantially equal, is ended within a predetermined period which commences from the start point of the preamble portion of each burst cell.

By controlling the detection time for the level detection of a burst cell in order for burst-by-burst AGC to be performed in this manner, the timing of switching the gain in burst-by-burst AGC can be limited to a predetermined period commencing from the start point of the preamble portion of the burst cell. As a result, normal signal reproduction in which there is no occurrence of bit errors is possible.

Moreover, by making it possible to set the timing of switching the gain in burst-by-burst AGC to within the leading end portion of the preamble portion of a burst cell, it is possible to reduce non-reproducible signal patterns in the preamble portion to a minimum, and achieve improved transmission efficiency.

An optical burst signal receiving device according to a third aspect of the present invention includes: a photoelectric conversion unit that photoelectrically converts an input optical burst signal into a current burst signal and outputs the current burst signal; a transimpedance amplifier that converts the current burst signal output from the photoelectric conversion unit into a phase-inverted voltage burst signal; an equalizing amplifier that performs equalizing amplification on the output signal from the transimpedance amplifier and then outputs the resulting signal; a level detection circuit that detects the level of the output signal from the transimpedance amplifier; and an automatic gain control circuit that controls at least one of the transimpedance amplifier and the equalizing amplifier such that the optimum gain is attained for the level of a burst cell detected by the level detection circuit, in which the level detection circuit has a control unit that, based on the output from the transimpedance amplifier, performs control for each one of a plurality of burst cells contained in the voltage burst signal such that the level detection operation by the level detection circuit is ended within a predetermined period commencing from the start point of a preamble portion of the burst cell.

In the optical burst signal receiving device of the present invention which has the above described structure, an input optical burst signal is photoelectrically converted by the photoelectric conversion unit and a current burst signal is output. This current burst signal is converted into a phase-inverted voltage burst signal by the transimpedance amplifier, and the resulting signal then undergoes equalizing amplification by the equalizing amplifier.

In addition, the level detection circuit detects the level of the output signal from the transimpedance amplifier, and, based on the detection result, the automatic gain control circuit controls at least one of the gain and phase of at least one of the transimpedance amplifier and the equalizing amplifier such that the level of each burst cell is substantially equal.

In the optical burst signal receiving device for a PON communication system which has the above described structure, the control unit performs control based on the output from the transimpedance amplifier such that the detection operation by the level detection circuit is ended within a predetermined period which commences from the start point of the preamble portion of each burst cell for the plurality of burst cells contained in the voltage burst signal.

By controlling the detection time for the level detection of a burst cell in order for burst-by-burst AGC to be performed in this manner, the timing of switching the gain in burst-by-burst AGC can be limited to a predetermined period commencing from the start point of the preamble portion of the burst cell. As a result, normal signal reproduction in which there is no occurrence of bit errors is possible.

Moreover, by making it possible to set the timing of switching the gain in burst-by-burst AGC to within the leading end portion of the preamble portion of a burst cell, it is possible to reduce non-reproducible signal patterns in the preamble portion to a minimum, and achieve improved transmission efficiency.

In the optical burst signal receiving device of the present invention, it is preferable for the control unit to have: a peak hold circuit that holds a peak value of a normal phase signal of the voltage burst signal output from the transimpedance amplifier; a differential amplifier that outputs an amplified signal of a difference between the normal phase signal of the voltage burst signal and an output signal from the peak hold circuit; a comparator that compares the level of the output signal from the differential amplifier with the level of a predetermined threshold value; and a flip-flop circuit that operates using an output signal from the comparator as a set signal, and using a burst signal reset that is input at a temporally earlier timing than the burst cell as a reset signal.

In an optical burst signal receiving device of the present invention which has the above described structure, in the control unit, the peak value of the normal phase signal of the voltage burst signal output from the transimpedance amplifier is held by the peak hold circuit, and the difference between the normal phase signal of the voltage burst signal and the output signal from the peak hold circuit is amplified by the differential amplifier.

The level of the output signal from the differential amplifier and the level of a predetermined threshold value are compared by the comparator.

By setting for the threshold value level which provides a reference for the comparison made by the comparator to a level which intersects each pulse of a pulse train in the preamble portion of the burst cell contained in the burst signal, the comparator only outputs burst signals that exceed that level.

At least one of the gain and phase of at least one of the transimpedance amplifier and the equalizing amplifier, which are amplifier systems of the optical burst signal receiving device, are controlled based on the output from the flip-flop circuit that uses the output signal from this comparator as a set signal, and uses the burst signal reset output from the optical burst signal receiving device at a temporally earlier timing than the burst cell as a reset signal.

Namely, it is possible to end the level detection operation of the level detection circuit by the time of the start of the output signal of the flip-flop circuit, which is the output signal from the control unit, and to thereafter control the gain or phase of the amplifier systems within the period during which the output signal from the control unit is being output.

By controlling the detection time for the level detection of a burst cell in order for burst-by-burst AGC to be performed in this manner, the timing of switching the gain in burst-by-burst AGC can be limited to a predetermined period commencing from the start point of the preamble portion of the burst cell. As a result, normal signal reproduction in which there is no occurrence of bit errors is possible.

Moreover, by making it possible to set the timing of switching the gain in burst-by-burst AGC to within the leading end portion of the preamble portion of a burst cell, it is possible to reduce non-reproducible signal patterns in the preamble portion to a minimum, and achieve improved transmission efficiency.

Moreover, in the optical burst signal receiving device of the present invention, it is preferable for the control unit to have: a peak hold circuit that holds a peak value of a normal phase signal of the voltage burst signal output from the transimpedance amplifier; a differential amplifier that outputs an amplified signal of a difference between the normal phase signal of the voltage burst signal and an output signal from the peak hold circuit; a comparator that compares the level of the output signal from the differential amplifier with the level of a predetermined threshold value; a flip-flop circuit that operates using an output signal from the comparator as a set signal, and using a burst signal reset that is output at a temporally earlier timing than the burst cell as a reset signal; and a delay circuit that delays an output signal from the flip-flop circuit by a predetermined time.

Moreover, in the optical burst signal receiving device of the present invention, it is preferable for the control unit to have: a peak hold circuit that holds a peak value of a normal phase signal of the voltage burst signal output from the transimpedance amplifier; a differential amplifier that outputs an amplified signal of a difference between the normal phase signal of the voltage burst signal and an output signal from the peak hold circuit; a comparator that compares the level of the output signal from the differential amplifier with the level of a predetermined threshold value; a delay circuit that delays an output signal from the comparator by a predetermined time; and a flip-flop circuit that operates using an output signal from the delay circuit as a set signal, and using a burst signal reset that is input at a temporally earlier timing than the burst cell as a reset signal.

In the optical burst signal receiving device of the present invention which has the above described structure, by delaying the output timing of the output signal from the control unit using the delay circuit, it is possible to extend the time of the detection operation by the level detection circuit to a predetermined range (i.e., a range that corresponds to the delay time) commencing from the start point of the preamble portion of a burst cell. This is effective when a plurality of bits in the preamble portion of a burst cell is to be subjected to level detection in burst-by-burst AGC.

### Advantageous Effects of the Invention

As has been described above, according to the optical burst signal receiving device of the present invention, by controlling the detection time for the level detection of a burst cell in order for burst-by-burst AGC to be performed, it is possible to limit the timing of switching the gain in burst-by-burst AGC to within a predetermined period commencing from the start point of the preamble portion of the burst cell. As a result, normal signal reproduction in which there is no occurrence of bit errors is possible.

Moreover, by making it possible to set the timing of switching the gain in burst-by-burst AGC to within the leading end portion of the preamble portion of a burst cell, it is possible to reduce non-reproducible signal patterns in the preamble portion to a minimum, and achieve improved transmission efficiency.

### BRIEF DESCRIPTION OF THE DRAWINGS

FIG. 1A is a block diagram showing the structure of an optical burst signal receiving device according to a first embodiment of the present invention.

FIG. 1B is a block diagram showing the specific structure of principal portions of the optical burst signal receiving device according to the first embodiment of the present invention.

FIG. 2 shows waveforms (a) to (e) which are waveform diagrams showing an operation of each section of the optical burst signal receiving device according to the first embodiment of the present invention shown in FIG. 1A.

FIG. 3 shows waveforms (f) to (i) which are waveform diagrams showing an operation of each section of the optical burst signal receiving device according to the first embodiment of the present invention shown in FIG. 1A.

FIG. 4 is a block diagram showing a structural example of a rise detection circuit of the optical burst signal receiving device according to the first embodiment of the present invention shown in FIG. 1A.

FIG. 5 shows waveforms (a) to (d) which are waveform diagrams showing an operation of each section of the rise detection circuit of the optical burst signal receiving device according to the first embodiment of the present invention shown in FIG. 1A.

FIG. 6 is a block diagram showing a structural example of a pulse width extension circuit of the optical burst signal receiving device according to the first embodiment of the present invention shown in FIG. 1A.

FIG. 7 shows waveforms (a) to (d) which are waveform diagrams showing an operation of each section of the pulse width extension circuit of the optical burst signal receiving device according to the first embodiment of the present invention shown in FIG. 1A.

FIG. 8 is a block diagram showing the structure of an optical burst signal receiving device according to a second embodiment of the present invention.

FIG. 9 is a block diagram showing the specific structure of a data detection section of the optical burst signal receiving device according to the second embodiment of the present invention shown in FIG. 8.

FIG. 10 shows waveforms (a) to (d) which are waveform diagrams showing an operation of each portion of the data detection section shown in FIG. 9.

FIG. 11 is a block diagram showing the specific structure of a level detection section of the optical burst signal receiving device according to the second embodiment of the present invention shown in FIG. 8.

FIG. 12 shows waveforms (a) to (f) which are waveform diagrams showing an operation of each portion of the level detection section shown in FIG. 11.

FIG. 13 is a block diagram showing another structural example of the data detection section of the optical burst signal receiving device according to the second embodiment of the present invention shown in FIG. 8.

FIG. 14 shows waveforms (a) to (e) which are waveform diagrams showing an operation of each portion of the data detection section shown in FIG. 13.

FIG. 15 is a block diagram showing another structural example of the data detection section of the optical burst signal receiving device according to the second embodiment of the present invention shown in FIG. 8.

FIG. 16 shows waveforms (a) to (e) which are waveform diagrams showing an operation of each portion of the data detection section shown in FIG. 15.

FIG. 17 shows waveforms (a) to (f) which are waveform diagrams showing an example of the operation of the level detection section when the data detection section shown in FIG. 13 or FIG. 15 is used for the data detection section.

FIG. 18 shows waveforms (a) to (f) which are waveform diagrams showing another example of the operation of the level detection section when the data detection section shown in FIG. 13 or FIG. 15 is used for the data detection section.

FIG. 19 is a block diagram showing another structural example of the data detection section of the optical burst signal receiving device according to the second embodiment of the present invention shown in FIG. 8.

FIG. 20 shows waveforms (a) to (d) which are waveform diagrams showing an operation of each portion of the data detection section shown in FIG. 19.

FIG. 21 is a block diagram showing the schematic structure of a PON communication system.

FIG. 22 is a block diagram showing the structure of a conventional optical burst signal receiving device.

FIG. 23 is a block diagram showing the specific structure of principal sections of the conventional optical burst signal receiving device.

FIG. 24 shows waveforms (a) and (b) which are used to illustrate a burst-by-burst AGC function.

FIG. 25 shows waveforms (a) to (d) which are waveform diagrams showing an operation of each section of the conventional optical burst signal receiving device shown in FIG. 23.

FIG. 26 is a view showing the structure of a burst cell.

FIG. 27 shows waveforms (a) to (e) which are waveform diagrams showing an example of the operation of the level detection section of the conventional optical burst signal receiving device shown in FIG. 23.

### DESCRIPTION OF THE REFERENCE SYMBOLS

101, 901 Photoreceptor
102 Transimpedance amplifier
102a, 902a Amplifier
102b, 902b Feedback resistor
103, 903A Reference voltage generating circuit
104 Threshold value comparator
105 Monitor window threshold value generating circuit
106, 903B Comparator
107, 903C Set/reset flip-flop (SR-FF) (flip-flop circuit)
108 Rise detection circuit
108A Delay circuit
108B AND circuit
109 Pulse width extension circuit
110 AND circuit
140 Input terminal
142 Output terminal
109A Operational amplifier
109B Condenser
109C Current source
109D Reference voltage generating circuit
109E Comparator
152 Output terminal
903 Level detection circuit
910 Reset terminal
911 Output terminal
1101 Photoreceptor element
1102 Transimpedance amplifier
1103 Equalizing amplifier
1104 Data detection section
1105 Level detection section
1104A Peak hold circuit
1104B Differential amplifier
1104C Threshold value generating circuit
1104D Comparator
1104E, 1105D Flip-flop circuit
1104F Delay circuit
1105A Reference voltage generating circuit
1105B Threshold value comparator
1105C AND circuit
1104G Bottom hold circuit
1106 Level detection circuit
1107 Automatic gain control circuit

### BEST MODE FOR CARRYING OUT THE INVENTION

### First Embodiment

An optical burst signal receiving device according to a first embodiment of the present invention will now be described with reference made to the drawings.

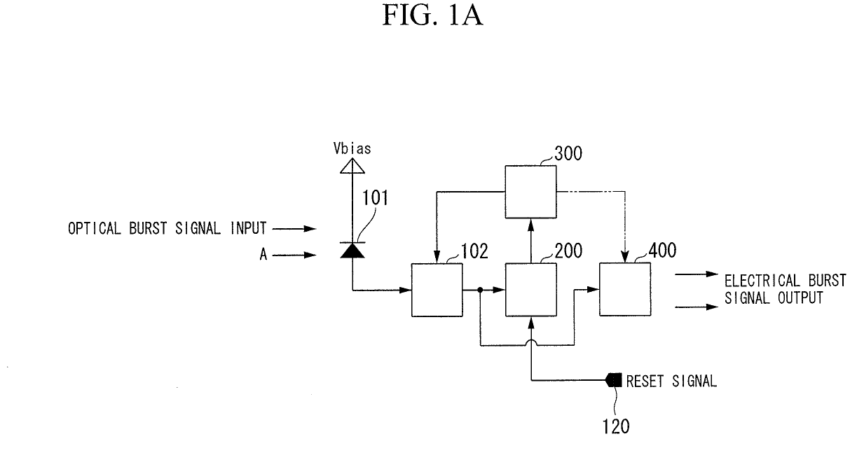

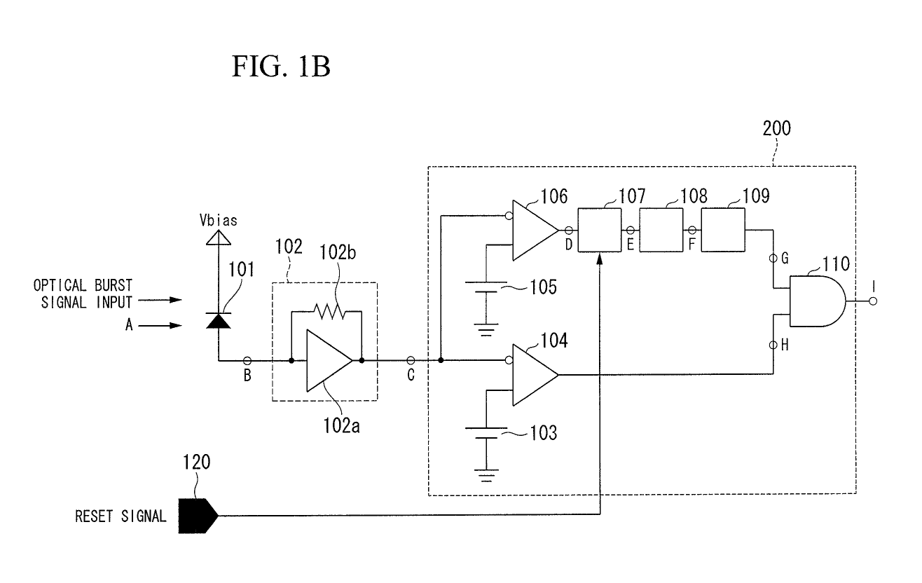

As is shown in FIG. 1A, the optical burst signal receiving device according to the first embodiment of the present invention is formed by a photoreceptor element 101, a transimpedance amplifier 102, a level detection circuit 200, an automatic gain control circuit 300, and an equalizing amplifier 400.

The photoreceptor element 101 has a function of photoelectrically converting input optical burst signals to generate current burst signals and outputting them. The photoreceptor element 101 corresponds to a photoelectric conversion unit of the present invention. The transimpedance amplifier 102 converts the current burst signals into voltage burst signals. The level detection circuit 200 detects output levels from the transimpedance amplifier 102. The automatic gain control circuit 300 optimizes at least one of the gain and phase of at least one of the transimpedance amplifier 102 and the equalizing amplifier 400 based on the detection results from the level detection circuit 200. The equalizing amplifier 400 performs equalizing amplification on the voltage burst signals which are the output signals from the transimpedance amplifier 102, and outputs the result as electrical burst signals having a substantially uniform level.

As is shown in FIG. 1B, the transimpedance amplifier 102 is formed by an amplifier 102a and a feedback resistor 102b. The transimpedance amplifier 102 has a function of converting the input current burst signals which are normal phase signals into voltage burst signals which are inverted phase signals in which the phase has been inverted.

Moreover, as is shown in FIG. 1B, the level detection circuit 200 has a reference voltage generating circuit 103, a threshold value comparator 104, a monitor window threshold value generating circuit 105, a comparator 106, a set/reset flip-flop (SR-FF) 107, a rise detection circuit 108, a pulse width extension circuit 109, and an AND circuit 110.

The monitor window threshold value generating circuit 105, the comparator 106, the set/reset flip-flop (SR-FF) 107, the rise detection circuit 108, and the pulse width extension circuit 109 correspond to a monitor window generating unit of the present invention.

The reference voltage generating circuit 103 generates a reference voltage signal which provides a reference for comparisons made by the threshold value comparator 104.

The threshold value comparator 104 has a function of comparing the level of a signal (a normal phase signal) obtained by performing phase inversion on the output signal from the transimpedance amplifier 102 which is an inverted phase signal, with the level of the reference voltage signal generated by the reference voltage generating circuit 103.

Here, when the threshold value level which forms the reference for comparisons made by the threshold value comparator 104 (namely, the level of the reference voltage signal from the reference voltage signal generating circuit 103) is set to the level of the voltage burst signal desired to be detected, the threshold value comparator 104 only outputs burst signals which exceed that level.

The monitor window threshold value generating circuit 105 generates a monitor window threshold value signal which provides a reference for the generating of a monitor window signal which regulates a level detection block of a predetermined period commencing from the start point of the preamble portion of a burst cell.

Here, the level of the monitor window threshold value signal is set to a lower level than the level of the reference voltage signal generated by the reference voltage signal generating circuit 103 which provides a reference for comparisons made by the threshold value comparator 104. This is in order to make it always possible to generate a monitor window signal even when a burst cell having a level which substantially matches the level of the reference voltage signal is input.

The comparator 106 has a function of comparing the level of the signal (a normal phase signal) obtained by performing phase inversion on the output signal (an inverted phase signal) from the transimpedance amplifier 102 with the level of the monitor window threshold value signal which provides a reference for the generating of a monitor window signal.

The set/reset flip-flop (SR-FF) 107 operates using the output from the comparator 106 as a set signal, and using the burst signal reset output from the reset terminal 120 at a timing earlier than the output of the burst cell as a reset signal.

The set/reset flip-flop (SR-FF) 107 outputs a signal which rises at the leading end portion of the preamble portion of each burst cell, and is made to fall by the burst signal reset input from the reset terminal 120. The signal output from this set/reset flip-flop (SR-FF) 107 is a pulse signal which rises at the output timing of a pulse signal at the leading end portion of the preamble portion of each burst cell output from the transimpedance amplifier 102, and which falls at the output timing of the burst signal reset.

The rise detection circuit 108 outputs a pulse signal at a timing of the rise of the output signal from the set/reset flip-flop (SR-FF) 107. Namely, the rise detection circuit 108 has a function of outputting a pulse signal which rises at the timing of the rise of the pulse signal at the leading end portion of the preamble portion of each burst cell.

The pulse width extension circuit 109 has a function of outputting as a monitor window signal a signal obtained by extending the pulse width of the pulse signal output from the rise detection circuit 108 by the size of the block of the monitor window which regulates the level detection block of the burst cell.

The AND circuit 110 has a function of performing an AND operation of the monitor window signal output from the pulse width extension circuit 109 and the output from the threshold value comparator 104. As a result of this, the level detection is only performed in the level detection block which is a predetermined period commencing from the start point of the preamble portion of a burst cell and which is regulated by the monitor window signal.

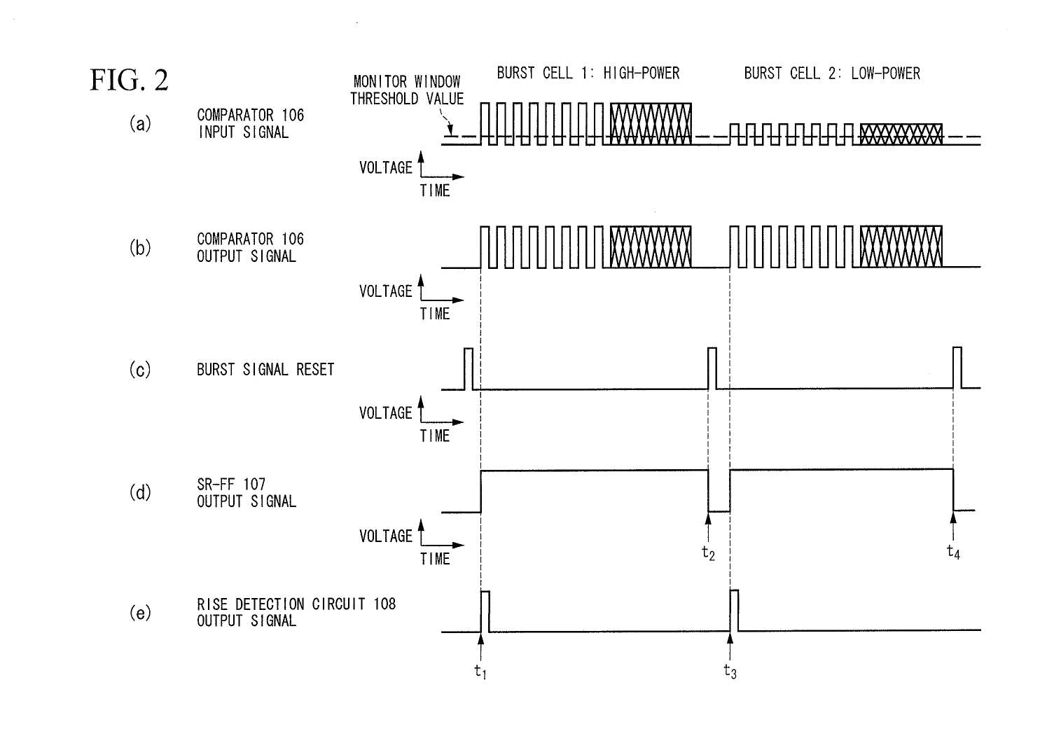

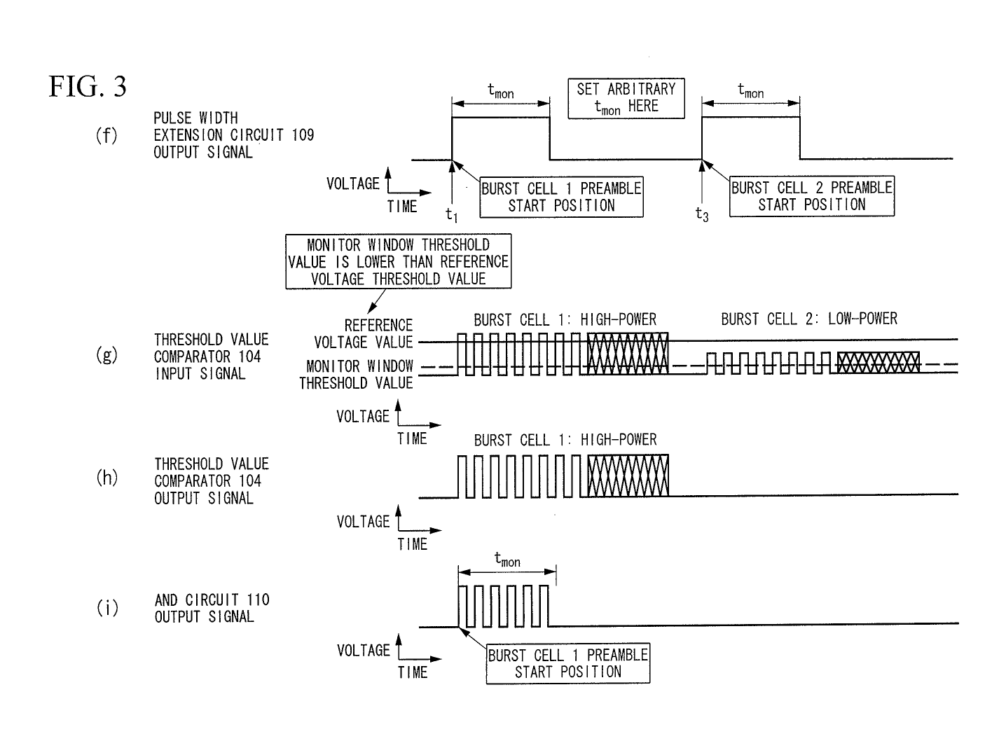

Operations of each section of the optical burst signal receiving device according to the embodiment of the present invention which has the above described structure will now be described with reference made to the operational waveform diagrams in waveforms (a) to (e) of FIG. 2 and waveforms (f) to (i) of FIG. 3.

As shown in the waveform (a) of FIG. 2, if an optical burst signal, in which a high-power burst cell 1 and a low-power burst cell 2 which follows the high-power burst cell 1 are output continuously, is input into the photoreceptor element 101, this optical burst signal is photoelectrically converted by the photoreceptor element 101 into a current burst signal, and is then input into the transimpedance amplifier 102.

In the transimpedance amplifier 102, the input current burst signal which is a normal phase signal is converted into a voltage burst signal which is an inverted phase signal in which the phase has been inverted, and the result is output.

A signal waveform which is a normal phase signal obtained by performing phase inversion on the output signal from the transimpedance amplifier 102 which is an inverted phase signal is input into one input terminal of the threshold value comparator 104 and into one input terminal of the comparator 106 (the waveform (a) of FIG. 2).

In the comparator 106, a comparison is made between the level of the signal (a normal phase signal) obtained by performing phase inversion on the output signal from the transimpedance amplifier 102, and the level of the monitor window threshold value signal which provides a reference for the generating of a monitor window signal and is output from the monitor window threshold value generating circuit 105. If the level of the signal obtained by performing phase inversion on the output signal from the transimpedance amplifier 102 exceeds the level of the monitor window threshold value signal, a pulse train signal that corresponds to the output signal (a pulse train signal) from the transimpedance amplifier 102 is output (the waveform (b) of FIG. 2).

Next, the output signal from the comparator 106 is input into the set terminal of the set/reset flip-flop (SR-FF) 107, and the burst signal reset which is output from the reset terminal 120 at a timing earlier than the output of the burst cell is input into the reset terminal of the set/reset flip-flop (SR-FF) 107 (the waveform (c) of FIG. 2).

The set/reset flip-flop (SR-FF) 107 operates using the output signal from the comparator 106 as a set signal, and the burst signal reset as a reset signal. As a result, a signal that rises at the leading end portion of the preamble portion of each burst cell and is made to fall by the burst signal reset is output from the set/reset flip-flop (SR-FF) 107. Specifically, the set/reset flip-flop (SR-FF) 107 outputs a signal that rises respectively at the rise timings t₁ and t₃ of the pulse signal at the leading end portions of the preamble portions of the burst cells 1 and 2, and that falls respectively at the rise timings t₂ and t₄ of the burst signal reset signal (the waveform (d) of FIG. 2).

Namely, the signal output from this set/reset flip-flop (SR-FF) 107 is a pulse signal that rises at the output timing of the pulse signal at the leading end portion of the preamble portion of each burst cell output from the transimpedance amplifier 102, and that falls at the output timing of the burst signal reset.

The rise detection circuit 108 outputs a pulse signal at the timing of the rise of the output signal from the set/reset flip-flop (SR-FF) 107. Namely, the rise detection circuit 108 outputs a pulse signal that rises at the rise timings (t₁, t₃) of the pulse signal at the leading end portions of the preamble portions of the burst cells (the waveform (e) of FIG. 2).

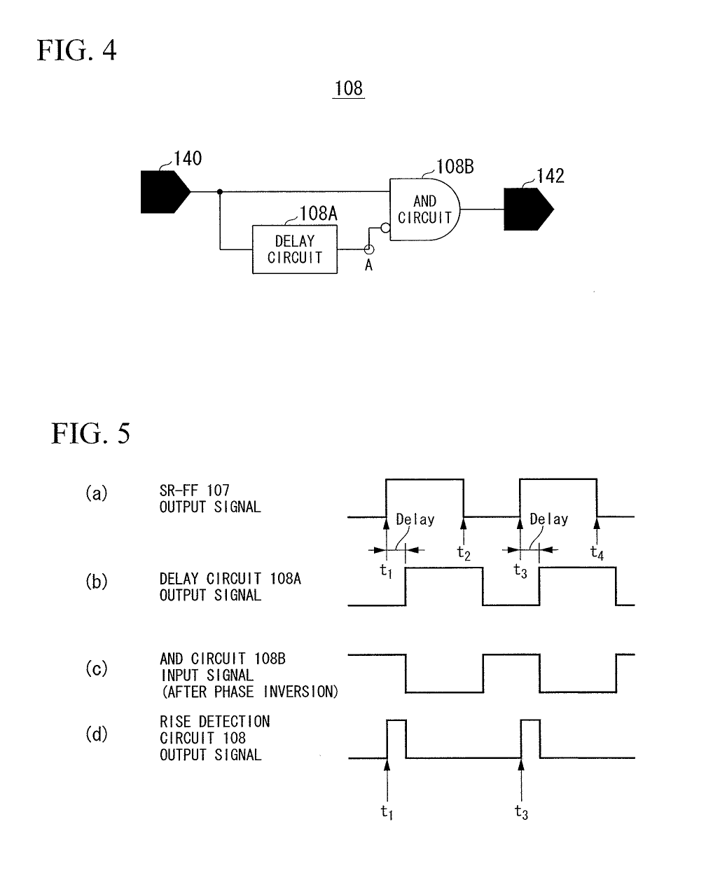

Here, the specific structure and operation of the rise detection circuit 108 will be described with reference made to FIG. 4 and waveforms (a) to (d) of FIG. 5.

FIG. 4 shows the specific structure of the rise detection circuit 108, while the waveforms (a) to (d) of FIG. 5 show operation waveforms of each section thereof. In FIG. 4, the rise detection circuit 108 has an input terminal 140, a delay circuit 108A, an AND circuit 108B, and an output terminal 142.

When the output signal from the set/reset flip-flop (SR-FF) 107 is input into the input terminal 140 (the waveform (a) of FIG. 5), this signal is input into the delay circuit 108A and into one input terminal of the AND circuit 108B. The output signal from the set/reset flip-flop (SR-FF) 107 is delayed for a predetermined time by the delay circuit 108A (the waveform (b) of FIG. 5).

The output signal from the delay signal 108A undergoes phase inversion (the waveform (c) of FIG. 5), and is input into the other input terminal of the AND circuit 108B.

In the AND circuit 108B, a logical product of the output signal from the set/reset flip-flop (SR-FF) 107 and the signal obtained by performing phase inversion on the output signal from the delay circuit 108A is obtained. As a result, a pulse signal that rises in synchronization with the rise timings (t₁, t₃) of the output signal from the set/reset flip-flop (SR-FF) 107 is output from the AND circuit 108B (the waveform (d) of FIG. 5).

In this manner, it is possible to detect the timing of rise of the output signal from the set/reset flip-flop (SR-FF) 107 using the rise detection circuit 108.

The pulse signal that is output from the rise detection circuit 108 is input into the pulse width extension circuit 109. The pulse width extension circuit 109 extends the pulse width of the pulse signal output from the rise detection circuit 108 by the amount of the block tₘₒₙ of the monitor window that regulates the level detection block of the burst cell, and then outputs this extended signal as a monitor window signal (the waveform (f) of FIG. 3).

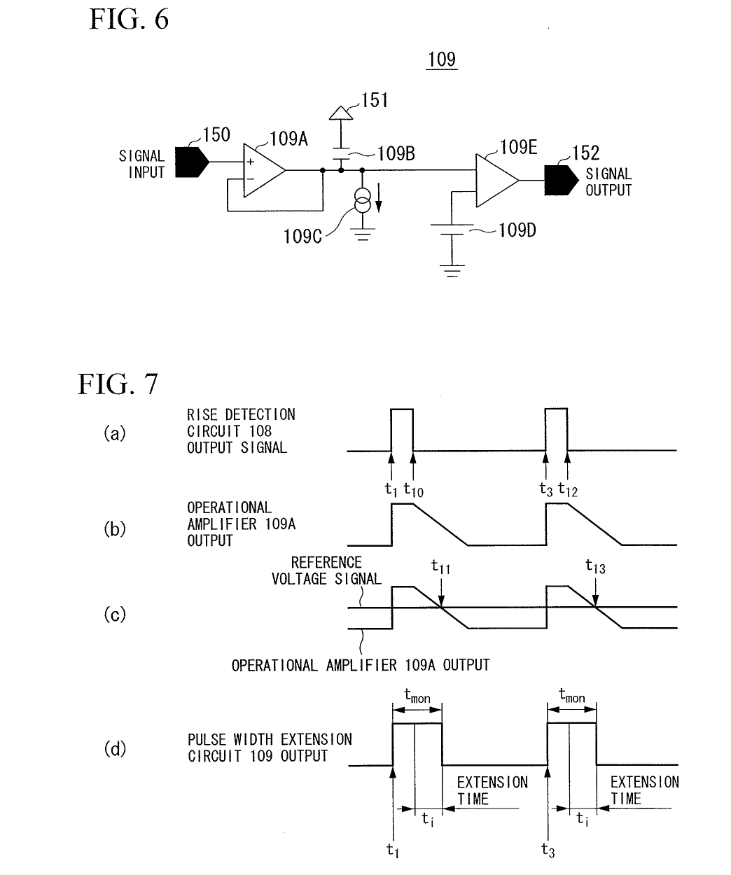

The specific structure of the pulse width extension circuit 109 is shown in FIG. 6, and operation waveforms of each section thereof are shown in waveform (a) to (d) of FIG. 7. In FIG. 6, the pulse width extension circuit 109 has an input terminal 150, an operational amplifier 109A, a power supply terminal 151, a condenser 109B that is connected between an output terminal of the operational amplifier 109A and the power supply terminal 151, a current source 109C that is connected between the output terminal of the operational amplifier 109A and an earth, a reference voltage generating circuit 109D that generates a reference voltage signal, a comparator 109E that compares the output signal from the operational amplifier 109A with the reference voltage signal, and an output terminal 152.

The pulse signal output from the rise detection circuit 108 is input into a non-inverting input terminal of the operational amplifier 109A. The condenser 109B and the current source 109C are connected to the output side of the operational amplifier 109A. The output terminal of the operational amplifier 109A is connected to an inverting input terminal so as to form a buffer amplifier. Accordingly, the operational amplifier 109A, the condenser 109B, and the current source 109C operate as a peak detection circuit.

When the output signal from the rise detection circuit 108, which is a pulse signal rising at the respective timings t₁ and t₃ and falls at the respective timings t₁₀ and t₁₂, is input from the input terminal 150 into the operational amplifier 109A (the waveform (a) of FIG. 7), the input signal is output from the output terminal of the operational amplifier 109A without any change. This output signal is charged and held by the condenser 109B, however, because there is a constant current outflow due to the presence of the current source 109C, the potential, namely, the output from the operational amplifier 109A whose peak value is being held by the condenser 109B is reduced at a particular time constant due to the discharge operation of the condenser 109B (the waveform (b) of FIG. 7). Note that this time constant can be arbitrarily set, for example, by changing the capacity of the condenser 109B or the current quantity of the current source 109C.

The level of the output signal from the operational amplifier 109A is compared with the level of the reference voltage signal by the comparator 109E (the waveform (c) of FIG. 7). As a result, a monitor window signal, which is a pulse signal having a pulse width tₘₒₙ and which rises at the respective timings t₁ and t₃, and which falls at the respective timings t₁₁ and t₁₃ where the level of the output signal from the operational amplifier 109A intersects with the level of the reference voltage signal, is output from the pulse width extension circuit 109 (the waveform (d) of FIG. 7). Namely, the pulse width extension circuit 109 outputs the pulse signal having the pulse width tₘₒₙ which is formed by extending the pulse width of the pulse signal output from the rise detection circuit 108 by the time tᵢ.

In this manner, the pulse width extension circuit 109 is able to output, as a monitor window signal, a signal which is formed by extending the output signal from the rise detection circuit 108 as far as the block (namely, tₘₒₙ) of the monitor window which regulates the level detection block of the burst cell.

Here, it is possible to arbitrarily alter the pulse width tₘₒₙ by changing the time constant or the reference voltage signal from the reference voltage generating circuit 109D. By doing this, it is possible to arbitrarily set a level detection block which is a predetermined time period commencing from the start point of the preamble portion of a burst cell.

Next, in the threshold value comparator 104, the output signal from the transimpedance amplifier 102 undergoes phase inversion, and the signal waveform of the resulting normal phase signal is input into one input terminal of the threshold value comparator 104 (the waveform (g) of FIG. 3).

In the threshold value comparator 104, the level of the signal (a normal phase signal) obtained by performing phase inversion on the output signal from the transimpedance amplifier 102 is compared with the level of the reference voltage signal generated by the reference voltage generating circuit 103.

In the waveform (g) of FIG. 3, the level of the threshold value which provides a reference for the comparison made by the threshold value comparator 104 (i.e., the level of the reference voltage signal) is set to a level which intersects each pulse of the pulse train of the burst cell 1 contained in the burst signal, however, the level of the burst cell 2 is lower than the level of the reference voltage signal. As a result of this, only a pulse train signal which corresponds to the pulse train signal of the burst cell 1 which has a level exceeding the level of this reference voltage signal is output from the threshold value comparator 104 (the waveform (h) of FIG. 3).

Next, the AND circuit 110 performs an AND operation on the monitor window signal, which is a pulse signal having a pulse width tₘₒₙ and is output from the pulse width extension circuit 109, and the output from the threshold value comparator 104. As a result of this, of the pulse train signal from the burst cell 1, only a pulse train signal which is within the block of the pulse width tₘₒₙ commencing from the start position of the preamble portion of the burst cell 1 is output from the AND circuit 110. Namely, the AND circuit 110 outputs the pulse train signal of the leading end portion of the preamble portion of the burst cell 1 which is within the block of the pulse width tₘₒₙ of the monitor window signal corresponding to the level detection block of the transimpedance amplifier 102 (the waveform (i) of FIG. 3).

Level detection of the output from the transimpedance amplifier 102 is performed based on the rise timing of the initial pulse of the pulse train signal output from the AND circuit 110.

Namely, level detection is only performed within the block of the pulse width tₘₒₙ of the monitor window signal (i.e., within the level detection block) which is a predetermined period commencing from the start point of the preamble portion of the burst cell which is regulated by the monitor window signal.

Accordingly, if the signal level of the burst cell 2 substantially matches the level of the reference voltage signal, only when there is a signal output by the AND circuit 110 within the output period of the monitor window signal (namely, within the block tₘₒₙ which extends from the timing t₃ which is the start position of the preamble portion of the burst cell 2 to the timing t₁₃), level detection is performed.

At least one of the gain and phase of at least one of the transimpedance amplifier 102 and the equalizing amplifier 400 is switched by the automatic gain control circuit 300 based on the output from the threshold value comparator 104 such that at least one of the gain and phase is switched only when a signal is output from the threshold value comparator 104 within the level detection block tₘₒₙ that is regulated by the monitor window signal. Namely, the switching of the gain or phase by the automatic gain control circuit 300 is performed without exception at the leading end portion of the preamble portion of a burst cell (namely, within the level detection block).

In other words, level detection is not performed in areas outside the level detection block regulated by the above-described monitor window signal and, therefore, the switching of the gain or phase by the automatic gain control circuit is not performed.

By controlling the detection block for the level detection of a burst cell in order for burst-by-burst AGC to be performed in this manner, the timing of switching the gain or phase in burst-by-burst AGC can be limited to a predetermined period commencing from the start point of the preamble portion of the burst cell. As a result, since there is no switching of the gain or phase in the payload portion or in the rear portion of the preamble portion, normal signal reproduction in which there is no occurrence of bit errors is possible.

In particular, as is shown in the waveform (d) of FIG. 27, if the signal level of the burst cell 2 substantially matches the level of the voltage reference signal, conventionally, there is a possibility that the level detection and switching of the gain or phase will be performed at the rear portion of the preamble portion or in the payload portion. However, in the level detection circuit 200 of the optical burst signal receiving device according to the first embodiment, the level detection and switching of the gain or phase is performed only when a signal is output from the threshold value comparator 104 within the level detection block tₘₒₙ, which is a predetermined period commencing from the start point of the preamble portion. Namely, even if a signal is output from the threshold value comparator 104 in an area outside the level detection block, the level detection and switching of the gain or phase is not performed. Accordingly, it is possible to prevent the level detection and switching of the gain or phase being performed in the rear portion of the preamble portion or in the payload portion, and it is possible to prevent bit errors being generated in the reproduced data.

Moreover, by making it possible to set the timing of switching the gain in burst-by-burst AGC to within the leading end portion of the preamble portion of a burst cell, it is possible to reduce non-reproducible signal patterns in the preamble portion to a minimum, and achieve improved transmission efficiency.

Here, the preamble portion is used in order to control the gain or phase of the amplifier system in the optical burst signal receiving device, and also to synchronize burst signals, on which equalizing amplification has been performed by the optical burst signal receiving device, with an external clock using CDR (clock data recovery). Because synchronization based on CDR is performed after the controlling of the gain or phase of the amplifier system by the optical burst signal receiving device, the rear portion of the preamble portion is used for the CDR-based synchronization.

The preamble portion is formed by a pattern in which “1” and “0” are repeated alternatingly. The bit number of the preamble portion differs depending on Standards such as ITU-T or IEEE (for example, 44 bits in GPON (1.25 Gbps) of ITU-T G984).

In order to obtain synchronization between the burst signal and an external clock using CDR, a certain amount of the pattern in which “1” and “0” are repeated alternatingly is required. The bit number required for the CDR differs depending on the type of CDR.

The maximum value of a bit number which can be used for controlling the gain or phase of an amplifier system in an optical burst signal receiving device provided with the burst-by-burst AGC function is obtained by subtracting the bit number required for the CDR from the bit number of the entire preamble portion. For example, if a burst signal has a preamble portion of 44 bits and the bit number required for the CDR when reproducing this burst signal is taken as 18 bits, it is possible for a maximum of 26 bits to be used in the optical burst signal receiving device. By appropriately setting a level detection block (i.e., a predetermined period commencing from the start point of the preamble portion) in the burst-by-burst AGC function, it is possible to set within a predetermined bit number range the bit number of the preamble portion which can be used for controlling the gain or phase of an amplifier system in an optical burst signal receiving device.

Here, as is described above, because the bit number of the preamble portion and the bit number required for the CDR differ depending on Standards such as ITU-T or IEEE and on the type of CDR, it is preferable that the bit number that can be used in the optical burst signal receiving device can be arbitrarily altered.

In the optical burst signal receiving device of the present embodiment, by altering the pulse width tₘₒₙ in the pulse width extension circuit 109, it is possible to set a level detection block, which is a predetermined period commencing from the start point of the preamble portion of a burst cell, to a desired value. Accordingly, it is possible to appropriately set the level detection block (namely, the bit number that can be used in the optical burst signal receiving device) in accordance with Standards such as ITU-T or IEEE and with the type of CDR.

### Second Embodiment

An optical burst signal receiving device according to a second embodiment of the present invention will now be described with reference made to the drawings.

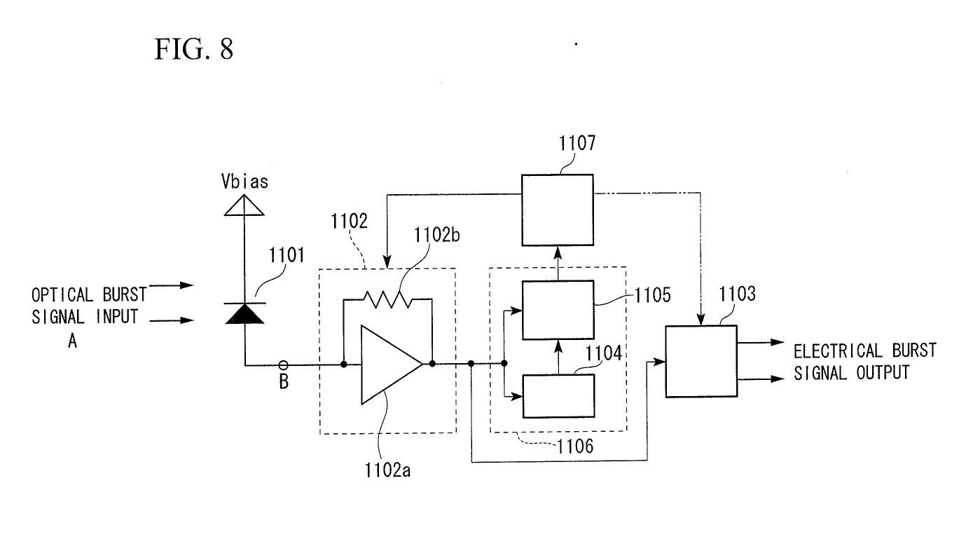

The structure of an optical burst signal receiving device for the PON communication system according to a second embodiment of the present invention is shown in FIG. 8. The optical burst signal receiving device according to the second embodiment of the present invention is formed by a photoreceptor element 1101, a transimpedance amplifier 1102, an equalizing amplifier 1103, a level detection circuit 1106, and an automatic gain control circuit 1107.

The photoreceptor element 1101 has a function of photoelectrically converting input optical burst signals to generate current burst signals and outputting them. The photoreceptor element 1101 corresponds to a photoelectric conversion unit of the present invention. The transimpedance amplifier 1102 converts the current burst signals into voltage burst signals. The level detection circuit 1106 detects output levels from the transimpedance amplifier 1102. The automatic gain control circuit 1107 optimizes at least one of the gain and phase of at least one of the transimpedance amplifier 1102 and the equalizing amplifier 1107 based on detection results from the level detection circuit 1106. The equalizing amplifier 1103 performs equalizing amplification on the voltage burst signals which are the output signals from the transimpedance amplifier 1102, and outputs the result as electrical burst signals having a substantially uniform level.

The transimpedance amplifier 1102 is formed by an amplifier 1102a and a feedback resistor 1102b. The transimpedance amplifier 1102 has a function of converting the input current burst signals which are normal phase signals into voltage burst signals which are inverted phase signals in which the phase has been inverted.

The equalizing amplifier 1103 has a function of performing equalizing amplification on the output signal from the transimpedance amplifier 1102 and outputting the result.

The level detection circuit 1106 is formed by a data detection section 1104 and a level detection section 1105.

The level detection section 1105 detects the level of the output signal from the transimpedance amplifier 1102.

The data detection section 1104 has a function of performing control based on the output from the transimpedance amplifier 1102 such that the detection operation by the level detection section 1105 is ended within a predetermined period which commences from the start point of the preamble portion of each burst cell for the plurality of burst cells contained in the voltage burst signal. The data detection section 1104 corresponds to a control unit of the present invention.

The photoreceptor element 1101 photoelectrically converts an input optical burst signal into a current burst signal, and outputs the result. This current burst signal is converted into a voltage burst signal whose phase has been inverted by the transimpedance amplifier 1102, and is output to the equalizing amplifier 1103. The voltage burst signal is input into the equalizing amplifier 1103, undergoes equalizing amplification by the equalizing amplifier 1103, and is output.

The level detection section 1105 detects the level of the output signal from the transimpedance amplifier 1102.

The data detection section 1104 performs control based on the voltage burst signal which is output from the transimpedance amplifier 1102 such that the detection operation by the level detection section 1105 is ended within a predetermined period which commences from the start point of the preamble portion of each burst cell for the plurality of burst cells contained in the voltage burst signal.

By controlling the detection time for the level detection of a burst cell for burst-by-burst AGC in this manner, it is possible to limit the timing of switching the gain in burst-by-burst AGC to a predetermined period commencing from the start point of the preamble portion of the burst cell. As a result, normal signal reproduction in which no bit errors are generated is possible.

Moreover, by making it possible to set the timing of switching the gain in burst-by-burst AGC to within the leading end portion of the preamble portion of a burst cell, it is possible to reduce non-reproducible signal patterns in the preamble portion to a minimum, and achieve improved transmission efficiency.

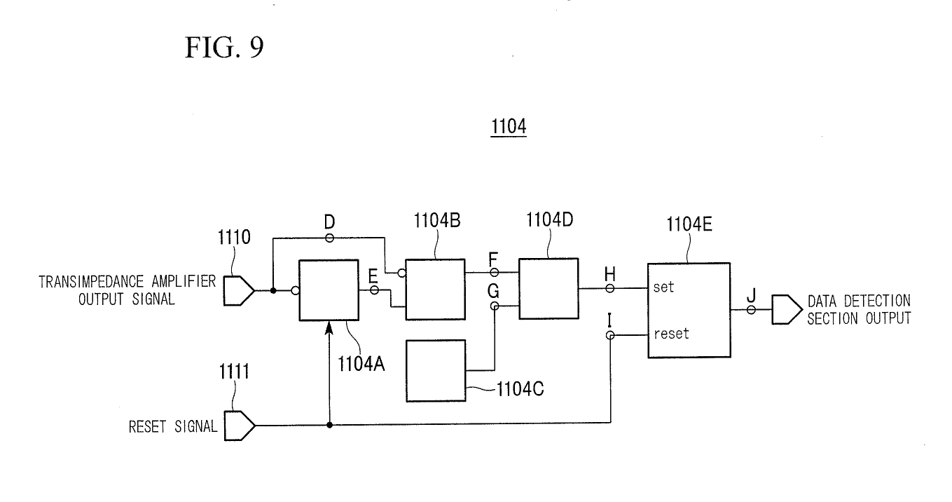

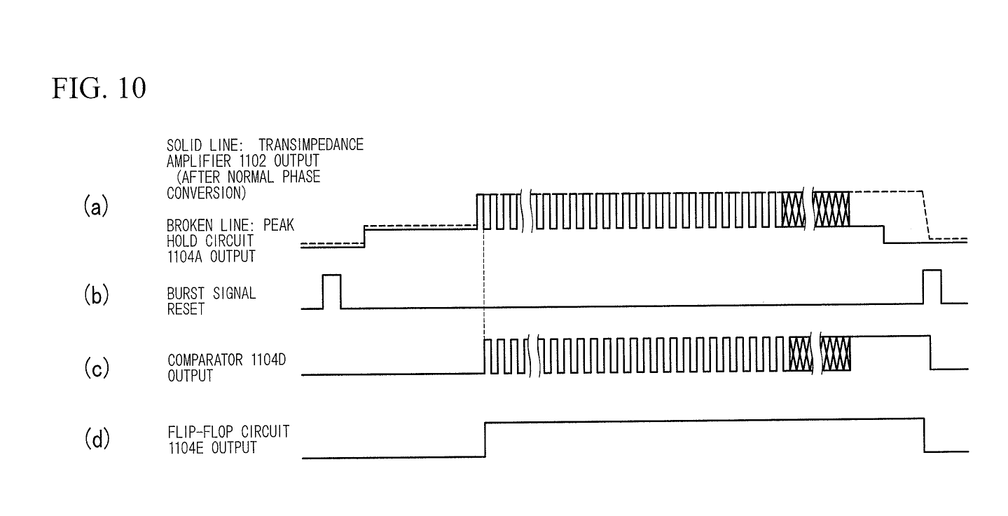

Next, the specific structure of the data detection section 1104 in the optical burst signal receiving device according to the embodiment of the present invention shown in FIG. 8 is shown in FIG. 9 with operation waveforms of each section thereof shown respectively in waveforms (a) to (d) of FIG. 10. In FIG. 9, the data detection section 1104 has a peak hold circuit 1104A, a differential amplifier 1104B, a threshold value generating circuit 1104C, a comparator 1104D, and a flip-flop circuit 1004E.

The peak hold circuit 1104A has a function of holding the peak value of the normal phase signal of the output voltage burst signal from the transimpedance amplifier 1102 (see FIG. 8) which is input via an input terminal 1110.

The differential amplifier 1104B has a function of outputting an amplified signal of the difference between the output signal from the peak hold circuit 1104A and a signal (a normal phase signal) obtained by performing phase inversion on the output signal (an inverted phase signal) from the transimpedance amplifier 1102.

Moreover, the threshold value generating circuit 1104C normally outputs a threshold value signal at a level that intersects the pulse train signal of the preamble portion of the received burst cell.

The comparator 1104D has a function of comparing the level of the output signal from the differential amplifier 1104B with the level of the threshold value signal output from the threshold value generating circuit 1104C.

The flip-flop circuit 1104E operates using the output signal from the comparator 1104D as a set signal, and using a burst signal reset input at a timing earlier than the burst cell as a reset signal.

The operations of the data detection section 1104 having the above described structure will now be described with reference made to the operation waveform diagrams shown in the waveforms (a) to (d) of FIG. 10. The voltage burst signal output from the transimpedance amplifier 1102 is input into the peak hold circuit 1104A and into the differential amplifier 1104B via the input terminal 1110. Here, because the phase of the output signal from the transimpedance amplifier 1102 is generally inverted 180°, the phase of the output signal from the transimpedance amplifier 1102 is inverted to 0°, namely, is converted into a normal phase signal, and this signal is then input into both the peak hold circuit 1104A and the differential amplifier 1104B.

The peak hold circuit 1104A holds the peak value of the signal obtained after the output signal from the transimpedance amplifier 1102 has undergone normal phase conversion, and then outputs this signal (the waveform (a) of FIG. 10). The burst signal reset (the waveform (b) of FIG. 10) is input from a reset terminal 1111 into the peak hold circuit 1104A. Because the peak hold circuit 1104A operates as a voltage follower while this reset signal is being input, the output signal from the peak hold circuit 1104A is equal to the input signal.

Next, the output signal from the peak hold circuit 1104A and the signal obtained after the output signal from the transimpedance amplifier 1102 has undergone normal phase conversion are input into the differential amplifier 1104B.

In the differential amplifier 1104B, a pulse is generated if there is a level difference between the output signal from the peak hold circuit 1104A and the signal obtained after the output signal from the transimpedance amplifier 1102 has undergone normal phase conversion. Accordingly, the leading end of the output from the differential amplifier 1104B is always identical to the second bit of the preamble portion of a burst cell.

The preamble portion of a burst cell includes in a pulse pattern in which “1” and “0” are repeated alternatingly. Because the potential of the signal of the first bit at the lead of the preamble portion matches that of the output signal from the peak hold circuit 1104A, no output signal is generated at that timing from the differential amplifier 1104B. Because the second bit of the preamble portion is always “0” (i.e., low level), at this point a level difference is generated for the first time between the output signal from the peak hold circuit 1104A and the output signal from the transimpedance amplifier 1102, and a pulse train signal is generated as the output signal from the differential amplifier 1104B.

The comparator 1104D compares the level of the output signal from the differential amplifier 1104B with the level of the threshold value signal output from the threshold value generating circuit 1104C, and outputs the comparison result (the waveform (c) of FIG. 10). The level of the threshold value signal generated by the threshold value generating circuit 1104C is normally set to a level that intersects the signal pattern of the preamble portion of the received burst cell.

The output signal from the comparator 1104D is input as a set signal into the set terminal of the flip-flop circuit 1104E. The burst signal reset (the waveform (b) of FIG. 10) which serves as a reset signal that is input at a temporally earlier timing than the burst cell is input from the reset terminal 1111 into the reset terminal of the flip-flop circuit 1104E. As a result, the flip-flop circuit 1104E outputs a pulse signal that rises at the timing of the rise of the first pulse of the output signal from the comparator 1104D, and falls at the timing of the rise of the burst reset signal subsequently input from the reset terminal 1111 (the waveform (d) of FIG. 10).

Because the output signal from the comparator 1104D is used as a set signal in the flip-flop circuit 1104E in this manner, the start point of the pulse of the output signal from the flip-flop circuit 1104E, which is the output signal from the data detection section 1104, is always identical to the second bit of the preamble portion.

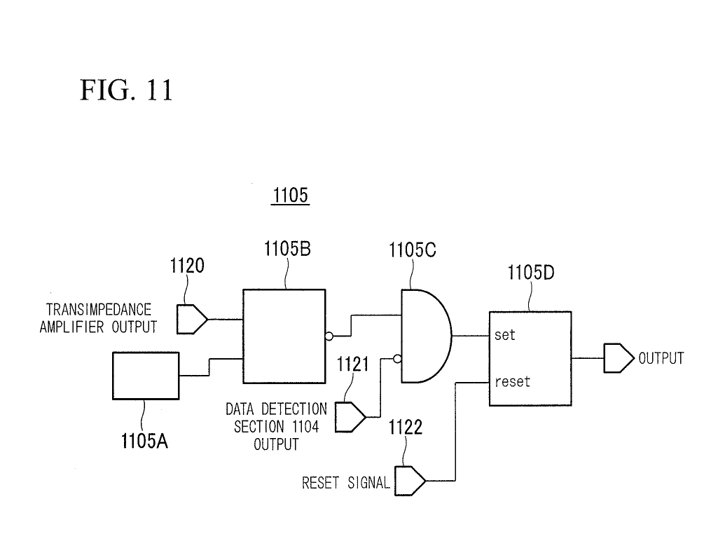

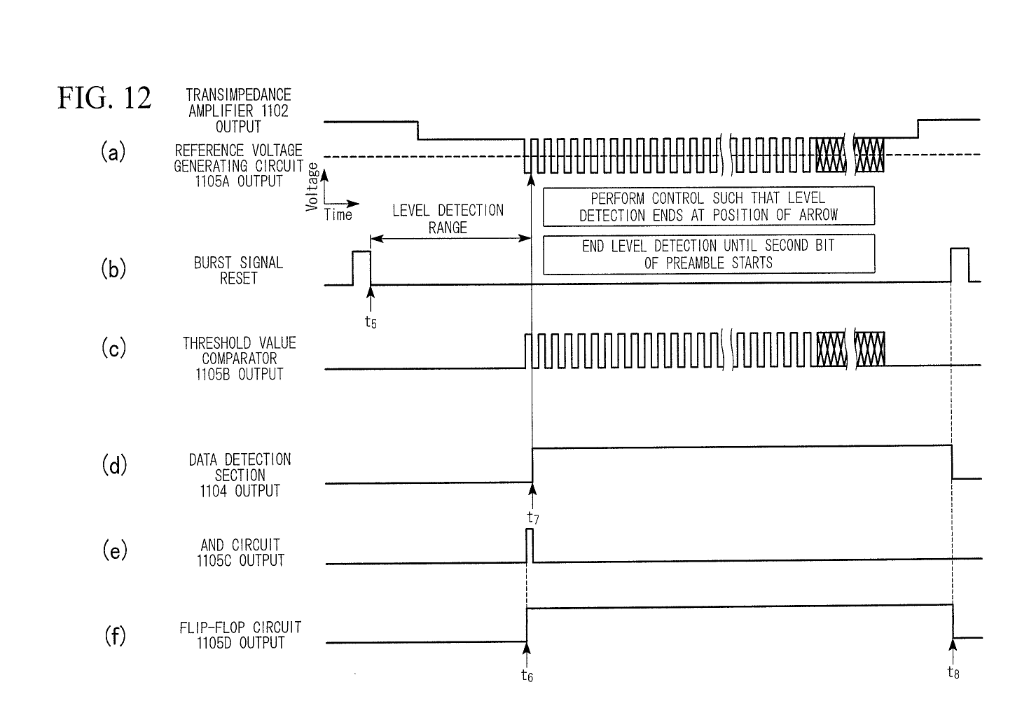

Next, the structure of the level detection section 1105 in the optical burst signal receiving device according to the second embodiment of the present invention shown in FIG. 8 is shown in FIG. 11 with operation waveforms of each section thereof shown respectively in waveform (a) to (f) of FIG. 12. In FIG. 11, the level detection section 1105 has a reference voltage generating circuit 1105A, a threshold value comparator 1105B, an AND circuit 1105C, and a flip-flop circuit 1105D.

If the level of the reference voltage signal output from the reference voltage generating circuit 1105A is set to the level of the voltage burst signal to be detected, the threshold value comparator 1105B only outputs burst signals that exceed that level.

The reference voltage generating circuit 1105A has a function of generating a reference voltage signal at the aforementioned level, and outputting it.

The threshold value comparator 1105B has a function of comparing the voltage burst signal output from the transimpedance amplifier 1102, which is an inverted phase signal, with the reference voltage signal output from the reference voltage generating circuit 1105A, and then outputting a signal obtained by performing phase inversion on the result thereof.

The AND circuit 1105C has a function of obtaining a logical product of a signal obtained by performing phase inversion on the output signal from the data detection section 1104 and the output signal from the threshold value comparator 1105B.

The flip-flop circuit 1105D has a function of operating using the output signal from the AND circuit 1105C as a set signal, and using the burst signal reset (the waveform (b) of FIG. 12) input at a timing earlier than the burst cell as a reset signal.

The voltage burst signal output from the transimpedance amplifier 1102 is input via an input terminal 1120 into one input terminal of the threshold value comparator 1105B, while the reference voltage signal is input from the reference voltage signal generating circuit 1105A into another input terminal of the threshold value comparator 1105B (the waveform (a) of FIG. 12). The threshold value comparator 1105B outputs a pulse signal within the range where the voltage burst signal output from the transimpedance amplifier 1102 exceeds the level of the reference voltage signal from the reference voltage signal generating circuit 1105A (the waveform (c) of FIG. 12).

The output from the threshold value comparator 1105B is input into one input terminal of the AND circuit 1105C, while the output signal from the data detection section 1104 (see FIG. 8, FIG. 9, and the waveforms (a) to (d) of FIG. 10) is input via an input terminal 1121 into the other input terminal of the AND circuit 1105C (the waveform (d) of FIG. 12).

In the AND circuit 1105C, because a logical product of the signal obtained by performing phase inversion on the output signal from the data detection section 1104 and the output signal from the threshold value comparator 1105B is obtained, the output signal from the threshold value comparator 1105B is not output from the AND circuit 1105C during the period in which the output signal is being output from the data detection section 1104. Namely, of the output signal from the threshold value comparator 1105B, only the first bit (namely, the portion where the output signal from the data detection section 1104 is not output) of the preamble portion of the burst cell is output from the AND circuit 1105C (the waveform (e) of FIG. 12).

This output signal from the AND circuit 1105C is input as a set signal into the flip-flop circuit 1105D. In addition, the burst signal reset, which serves as a reset signal and is input at a temporally earlier timing than the burst cell (the waveform (b) of FIG. 12), is input from the reset terminal 1122 into the reset terminal of the flip-flop circuit 1105D. As a result, a pulse signal, which rises at the rise timing t₆ of a single pulse which corresponds to the first bit of the preamble portion of the burst cell output from the AND circuit 1105C, and falls at the rise timing t₈ of the burst cell signal reset which is input subsequently to the timing t₆, is output from the flip-flop circuit 1105D (the waveform (f) of FIG. 12).

Here, the level detection of the voltage burst signal (i.e., the output signal from the transimpedance amplifier 1102) performed by the level detection section 1105 is controlled based on the output signal from the data detection section 1104 such that, for each burst cell, the level detection finishes within a predetermined period commencing from the start point of the preamble portion of the burst cell. For example, in the example shown in the waveforms (a) to (f) of FIG. 12, the level detection finishes within a period from the fall timing t₅ of the burst signal reset input at a timing prior to the input of the burst cell, until the rise timing t₇ of the output signal from the data detection section 1104. In addition, it becomes possible to control at least one of the gain and the phase of at least one of the transimpedance amplifier 1102 and the equalizing amplifier 1103, which are amplifier systems of the optical burst signal receiving device, within the output period of the output signal from the flip-flop circuit 1105D which forms the output from the level detection section 1105. In the level detection section 1105 of the present embodiment, the gain and phase control is performed within an arbitrary block commencing from the start point of the preamble portion of the burst cell.

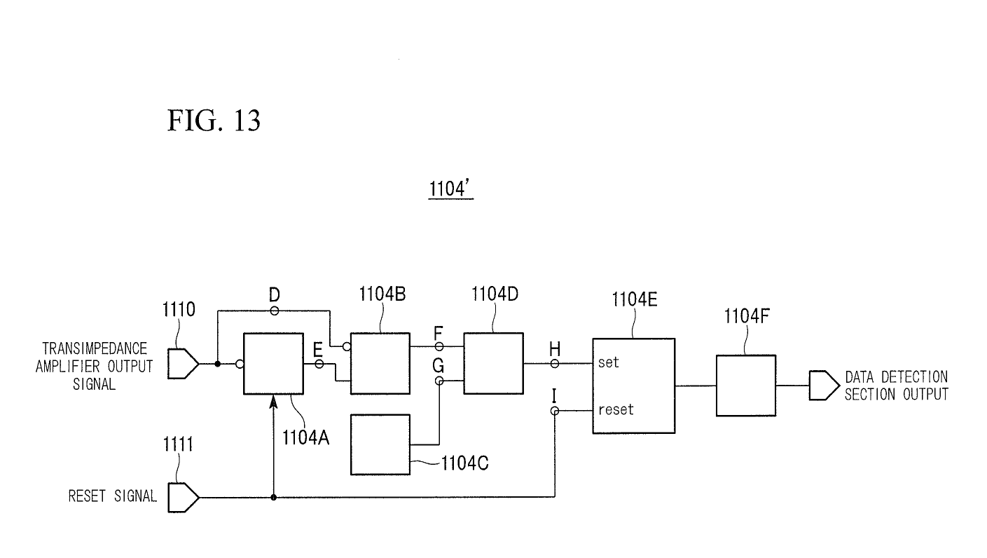

It is also possible for the period of the level detection of the voltage burst signal by the level detection section 1105 to be made adjustable. This can be achieved by delaying the rise timing of the pulse signal which is the output signal from the data detection section 1104 shown in FIG. 9. An example of the structure of a data detection section constructed in this manner is shown in FIG. 13. In a data detection section 1104′, a delay circuit 1104F is provided on the output side of the flip-flop circuit 1104E in the data detection section 1104 shown in FIG. 9.

In FIG. 13, the data detection section 1104′ has the peak hold circuit 1104A, the differential amplifier 1104B, the threshold value generating circuit 1104C, the comparator 1104D, the flip-flop circuit 1004E, and the delay circuit 1104F.

The peak hold circuit 1104A has a function of holding the peak value of the normal phase signal of the output voltage burst signal from the transimpedance amplifier 1102 (see FIG. 8) which is input via the input terminal 1110.

The differential amplifier 1104B has a function of outputting an amplified signal of the difference between the normal phase signal of the voltage burst signal, and the output signal from the peak hold circuit 1104A.

Moreover, the threshold value generating circuit 1104C normally outputs a threshold value signal at a level that intersects the pulse train signal of the preamble portion of the received burst cell.

The comparator 1104D has a function of comparing the level of the output signal from the differential amplifier 1104B with the level of the threshold value signal output from the threshold value generating circuit 1104C.

The flip-flop circuit 1104E operates using the output signal from the comparator 1104D as a set signal, and using the burst signal reset input at a timing earlier than the burst cell as a reset signal.

The delay circuit 1104F has a function of delaying the output signal from the flip-flop circuit 1104E for a predetermined time.

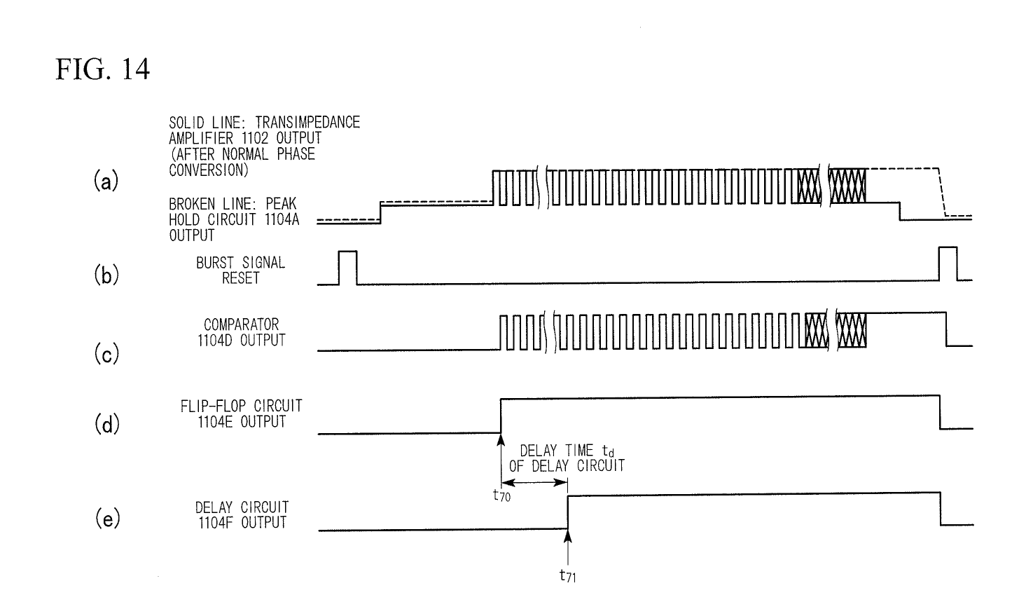

Operation waveforms of each section of the data detection section 1104′ having the above described structure are shown in waveforms (a) to (e) of FIG. 14. The operation waveforms from the time when the output signal from the transimpedance amplifier 1102 is input from the input terminal 1110 until the time when the output signal is output from the flip-flop circuit 1104E are the same as those shown in the waveform (a) to (d) of FIG. 10, and therefore a repeated explanation thereof will be omitted. The pulse signal which is the output signal from the flip-flop circuit 1104E rises at the rise timing (i.e., at a timing t₇₀) of the pulse signal output from the comparator 1104D (the waveforms (c) and (d) of FIG. 14). However, this output signal is delayed by a delay time t_{d} by the delay circuit 1104F, and the pulse signal that rises at a timing t₇₁ is output as an output signal from the data detection section 1104′ (the waveform (e) of FIG. 14).

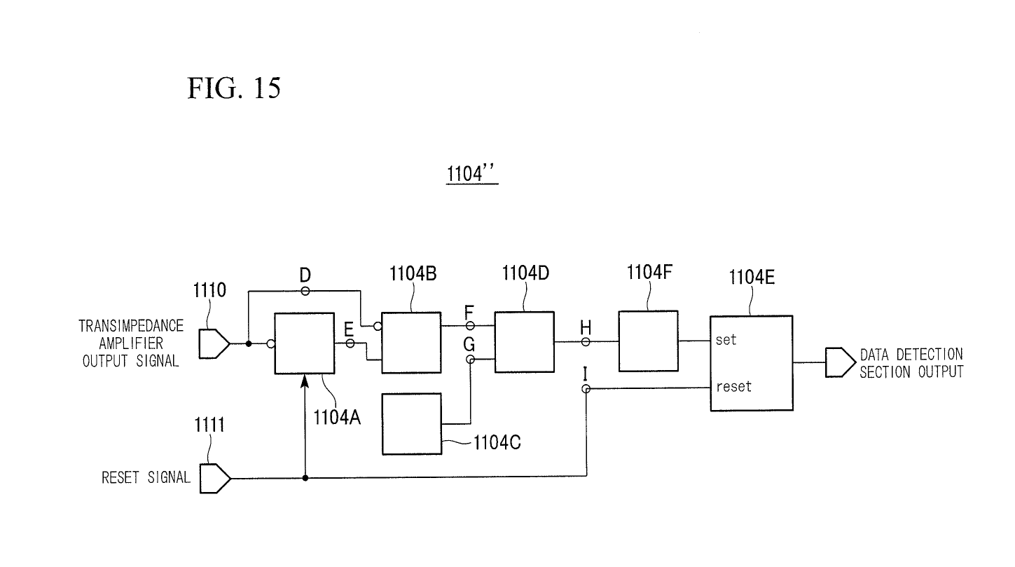

Moreover, another structural example of a data detection section which is structured such that the period of the level detection of the voltage burst signal by the level detection section 1105 is adjustable. In a data detection section 1104″ shown in FIG. 15, the delay circuit 1104F is provided on the input side of the flip-flop circuit 1104E in the data detection section 1104 shown in FIG. 9.

In FIG. 15, the data detection section 1104″ has the peak hold circuit 1104A, the differential amplifier 1104B, the threshold value generating circuit 1104C, the comparator 1104D, the delay circuit 1104F, and the flip-flop circuit 1104E.

In the data detection section 1104″ having the above described structure, a signal obtained by delaying the output signal from the comparator 1104D of the data detection section 1104 shown in FIG. 9 by a predetermined time t_{d} using the delay circuit 1104F is used as a set signal of the flip-flop circuit 1104E. As a result, the output timing of the output signal from the flip-flop circuit 1104E is delayed by the time t_{d}.

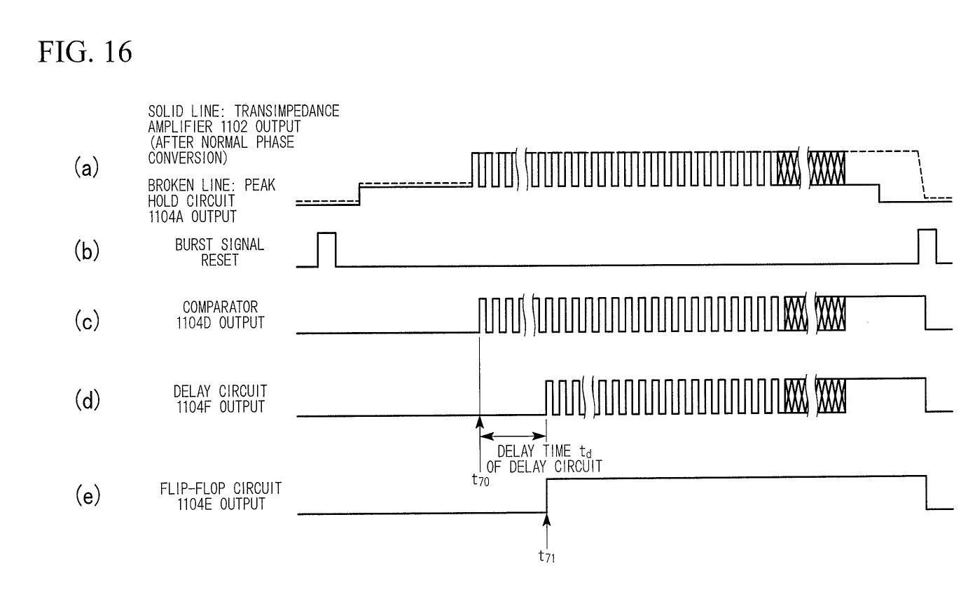

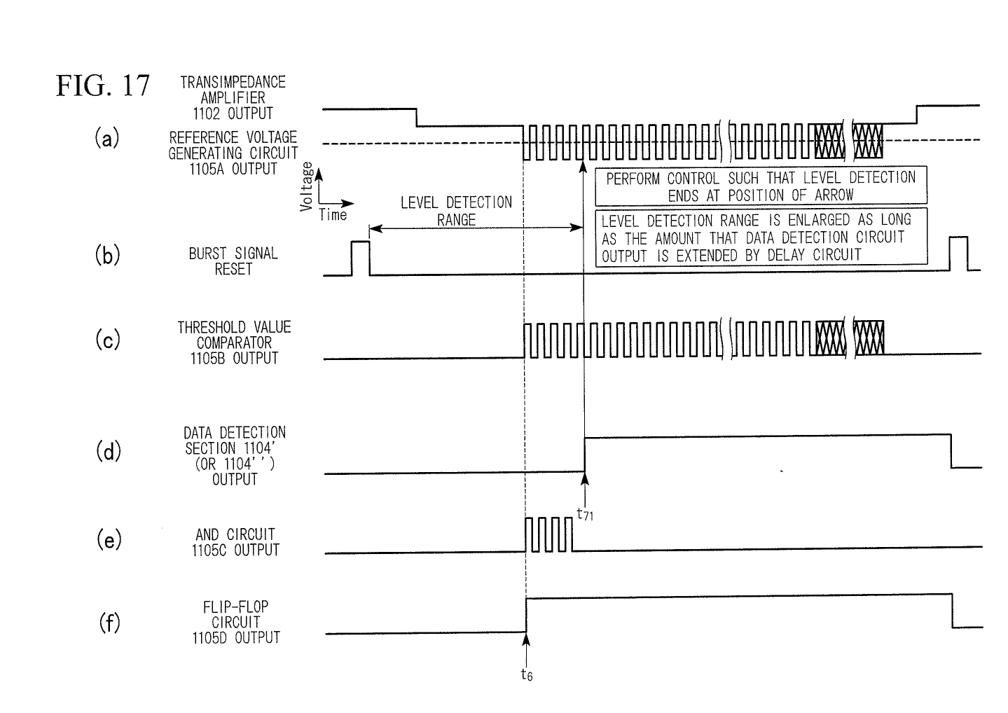

By providing the delay circuit 1104F on the input side or the output side of the flip-flop circuit 1104E as in the case of the data detection sections 1104′ and 1104″ shown in FIG. 13 and FIG. 15, as is shown in the waveforms (a) to (e) of FIG. 14 and waveforms (a) to (e) of FIG. 16, it is possible to delay the output timing of the output signal of the data detection section 1104′ or 1104″. Operation waveforms of the level detection section 1105 (see FIG. 11) in this case are shown in waveforms (a) to (f) of FIG. 17.

As is shown in the waveform (d) of FIG. 17, by delaying the output timing of the output signal from the data detection section 1104′ or 1104″ from the timing t₇₀ to the timing t₇₁ using the delay circuit 1104F, the output from the threshold value comparator 1105B which is output within a period from the timing t₆ to the timing t₇₁, namely, the pulse signal in the preamble portion of the burst cell, is output from the AND circuit 1105C to the flip-flop circuit 1105D.

In the flip-flop circuit 1105D, a pulse signal that rises at the rise timing t₆ of the rise of the first pulse of the output signal from the AND circuit 1105C and that falls at the timing t₈ of the rise of the burst signal reset subsequently input is output (the waveform (f) of FIG. 17).

The gain switching of the burst-by-burst AGC function can be performed selectively in either of the output period of the pulse signal output from the flip-flop circuit 1105D.

By delaying the output signal from the data detection section in this manner, it is possible to extend the level detection period (i.e., the period from the time when the burst signal reset, which is input at an earlier timing than the input of the burst cell, is output, until the output start timing of the output signal from the data detection section) used in the burst-by-burst AGC.

Namely, because it is possible to increase the bit number of the signal whose level is being detected (i.e., it is possible to use the pulse signal of a plurality of bits in the preamble portion for level detection) by lengthening the level detection period, there is a possibility that level detection can be performed more accurately. For example, in cases in which the output of the first bit of the preamble portion of a burst cell is distorted, by performing the level detection over a plurality of bits, accurate level detection can be performed using the other signal portions.

Furthermore, by altering the delay time t_{d} of the delay circuit 1104F, it becomes possible to arbitrarily set a level detection block which is a predetermined period commencing from the time when the burst signal reset, which is input at an earlier timing than the input of the burst signal, is output. Accordingly, it is possible to set an appropriate level detection block (namely, the number of bits that can be used in the optical burst signal receiving device) in accordance with Standards such as ITU-T and IEEE or with the type of CDR.

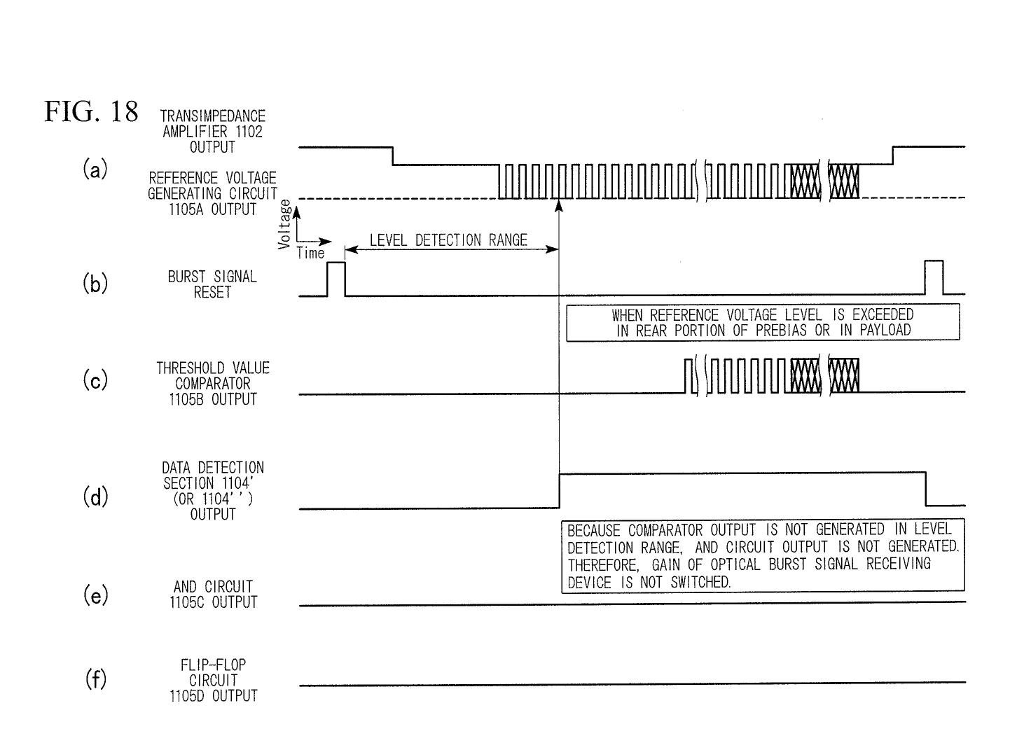

Next, a case which has been problematic in the conventional technology will be considered in which, in a level detection circuit, the level of a voltage burst signal, which is an output signal from a transimpedance amplifier, substantially matches the level of a reference voltage signal, which is an output signal from a reference voltage generating circuit, and an output from a threshold value comparator is initially created in the rear portion of the preamble portion or in the payload portion. Operation waveforms of each section of the level detection circuit in this case are shown in waveforms (a) to (f) of FIG. 18.

In this case, as shown in the waveform (c) of FIG. 18, the threshold value comparator 1105B of the level detection circuit 1105 compares the level of the voltage burst signal, which is the output signal from the transimpedance amplifier 1102 (see FIG. 8), with the level of the reference voltage signal, which is the output signal from the reference voltage generating circuit 1105A, and outputs a pulse train signal that is initially generated in the rear portion of the preamble portion or in the payload portion. However, because a logical product of the output signal from the threshold value comparator 1105B and the output signal from the data detection section 1104 is obtained by the AND circuit 1105C, no signal is output from the AND circuit 1105C.

Accordingly, because the flip-flop circuit 1105D located at a later stage than the AND circuit 1105C does not operate, a control signal for the burst-by-burst AGC of the optical burst signal receiving device is not generated and, therefore, the gain or phase control is not performed. This operation provides a solution to the conventional problem of the control of the gain or phase in burst-by-burst AGC being generated at a contingent timing in the output period of a burst cell when the level of a voltage burst signal, which is an output signal from a transimpedance amplifier, substantially matches the level of a threshold value signal, which is an output signal from a threshold value generating circuit.

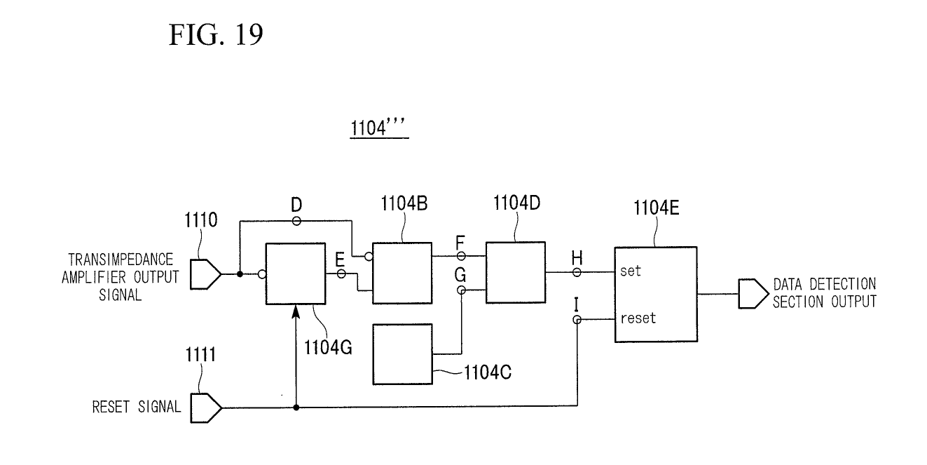

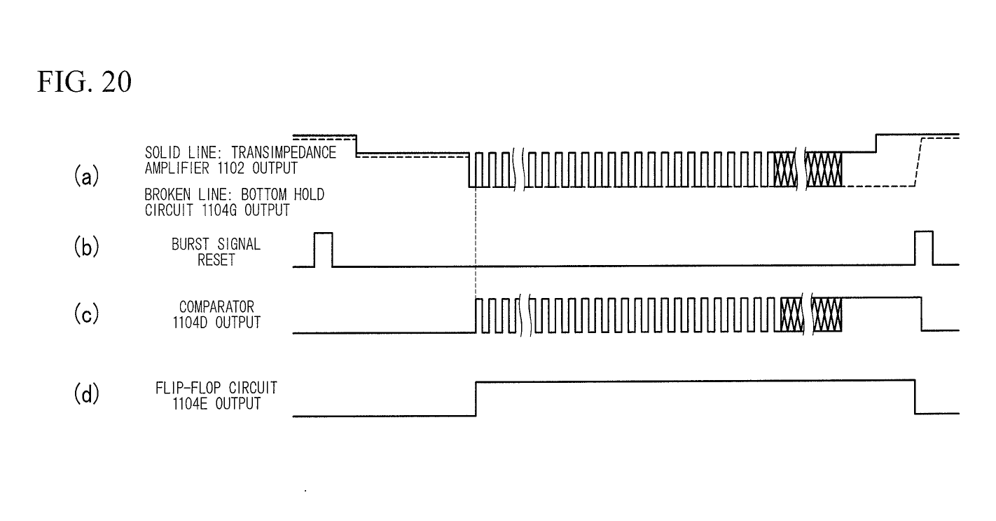

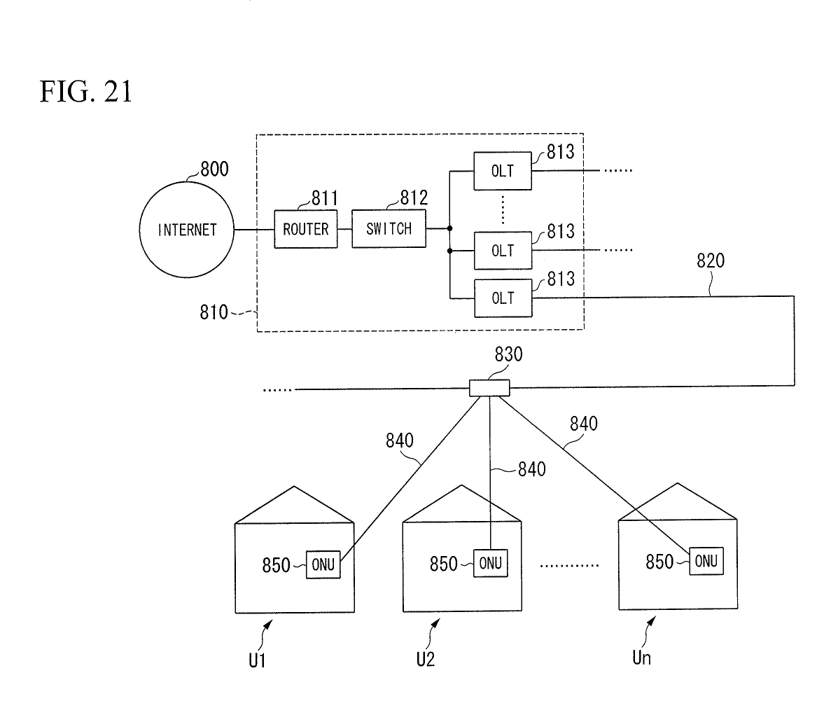

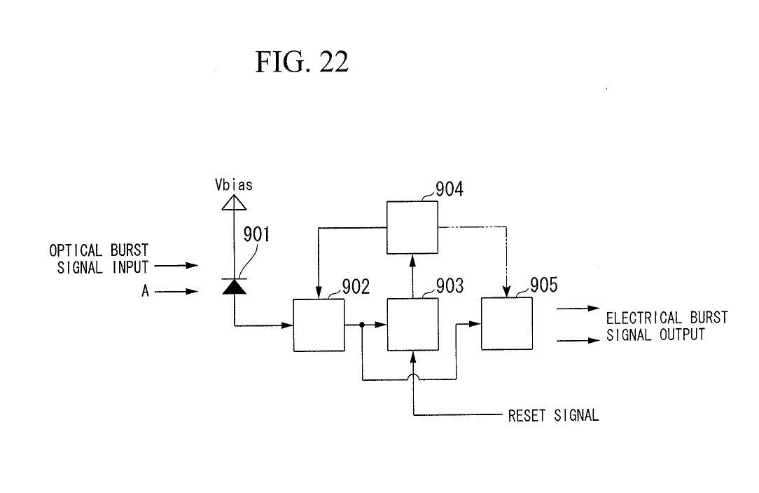

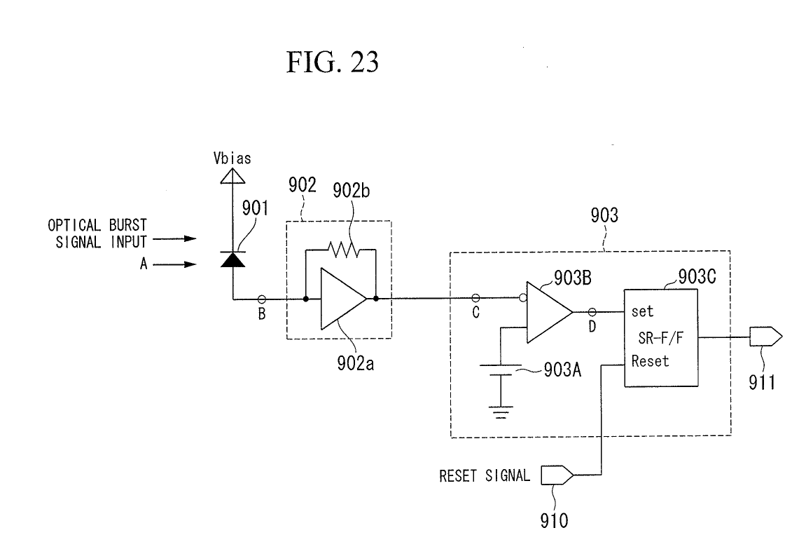

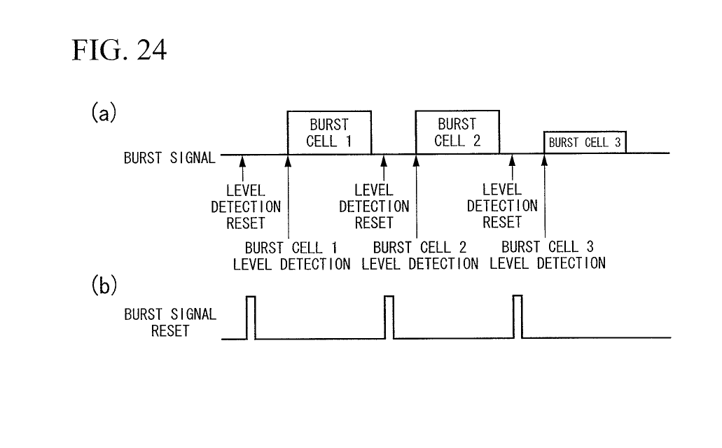

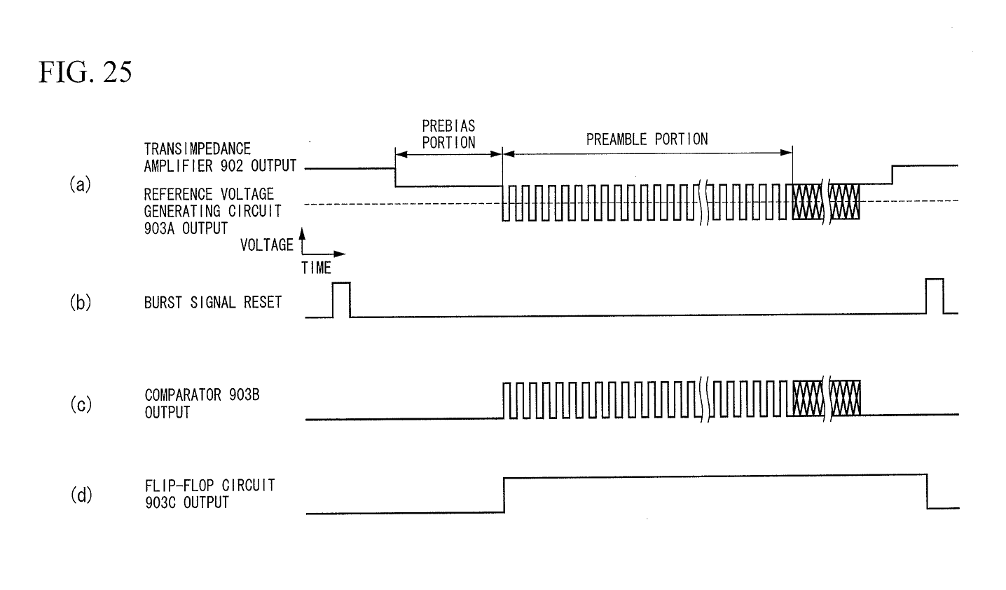

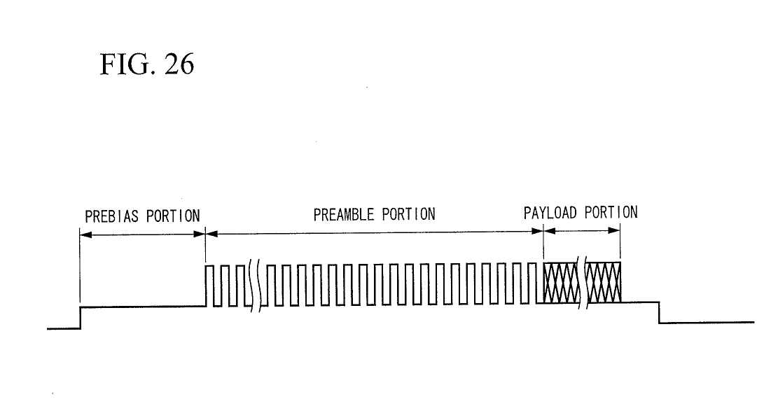

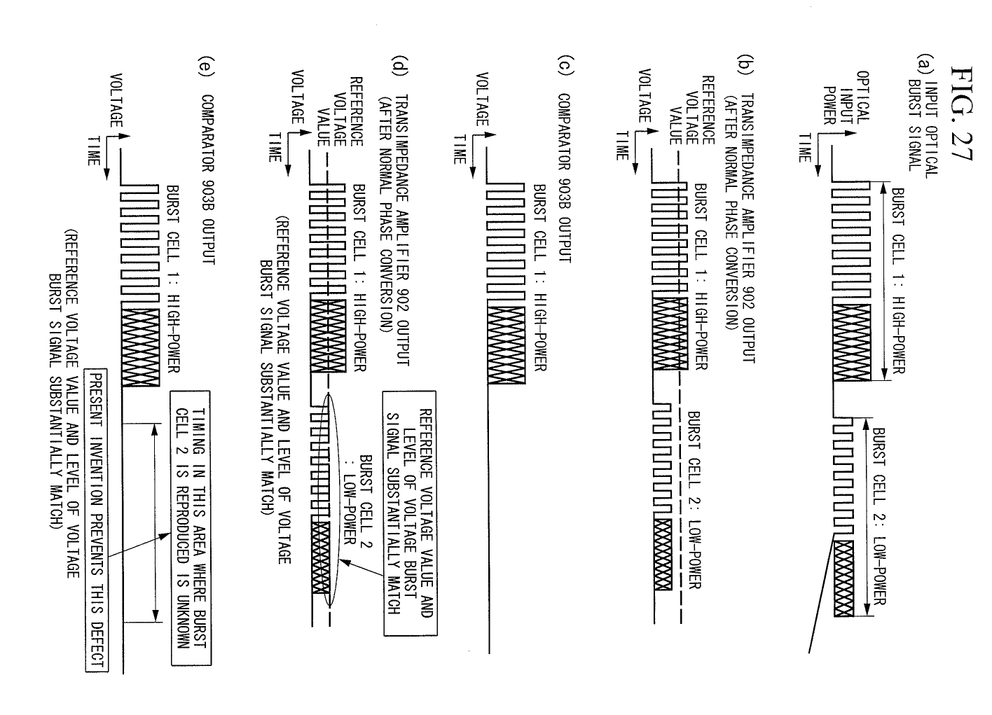

Next, another structural example of a data detection section is shown in FIG. 19 with operation waveforms of each section thereof shown in waveforms (a) to (d) of FIG. 20. The difference between the structure of this data detection section 1104′″ and that of the data detection section 1104 shown in FIG. 9 is the fact that, instead of the peak hold circuit 1104A shown in FIG. 9, there is provided a bottom hold circuit 1104G which has a function of holding the level of the minimum value of an input signal. The remaining structure is the same as that of the data detection section 1104 shown in FIG. 9.

In FIG. 19, the data detection section 1104′″ is provided with the bottom hold circuit 1104G, the differential amplifier 1104B, the threshold value generating circuit 1104C, the comparator 1104D, and the flip-flop circuit 1104E.

The bottom hold circuit 1104G has a function of holding the minimum value of the output voltage burst signal (i.e., an inverted phase signal) from the transimpedance amplifier 1102 (see FIG. 8) which is input into the bottom hold circuit 1104G via the input terminal 1110.

The differential amplifier 1104B has a function of outputting an amplified signal of the difference between the voltage burst signal, which is an inverted phase signal, and the output signal from the bottom hold circuit 1104G.

Moreover, the threshold value generating circuit 1104C normally outputs a threshold value signal at a level that intersects the pulse train signal of the preamble portion of the received burst cell.

The comparator 1104D has a function of comparing the level of the output signal from the differential amplifier 1104B with the level of the threshold value signal output from the threshold value generating circuit 1104C.

The flip-flop circuit 1104E operates using the output signal from the comparator 1104D as a set signal, and using the burst signal reset input from the reset terminal 1111 at a timing earlier than the burst cell as a reset signal.

Operations of each section of the data detection section 1104′″ having the above described structure will now be described with reference made to the operation waveform diagrams (a) to (d) of FIG. 20. The voltage burst signal output from the transimpedance amplifier 1102 is input into the bottom hold circuit 1104G and into the differential amplifier 1104B via the input terminal 1110. Here, the phase of the output signal from the transimpedance amplifier 1102 is inverted 180° (namely, is left as an inverted phase signal) (the waveform (a) of FIG. 20).

The bottom hold circuit 1104G holds the minimum value of the output signal from the transimpedance amplifier 1102, and outputs the result (the waveform (a) of FIG. 20). The burst signal reset (the waveform (b) of FIG. 20) is input into this bottom hold circuit 1104G. Because the bottom hold circuit 1104G operates as a voltage follower while this reset signal is being input, the output signal from the bottom hold circuit 1104G is equal to the input signal.

Next, the output signal from the bottom hold circuit 1104G and the output signal from the transimpedance amplifier 1102 (an inverted phase signal) are input into the differential amplifier 1104B.

In the differential amplifier 1104B, a pulse is generated if there is a level difference between the output signal from the bottom hold circuit 1104G and the output from the transimpedance amplifier 1102. Accordingly, the leading end of the output from the differential amplifier 1104B is always identical to the second bit of the preamble portion of a burst cell.

The preamble portion of a burst cell includes a pulse pattern in which “1” and “0” are repeated alternatingly. Because the potential of the signal of the first bit at the lead of the preamble portion matches that of the output signal from the bottom hold circuit 1104G, no output signal is generated at that timing from the differential amplifier 1104B. In the data detection section 1104′″, because the second bit of the preamble portion is always “1” (i.e., high level), at this point a level difference is generated for the first time between the output signal from the bottom hold circuit 1104G and the output signal from the transimpedance amplifier 1102, and a pulse train signal is generated as the output signal from the differential amplifier 1104B.

The comparator 1104D compares the level of the output signal from the differential amplifier 1104B with the level of the threshold value signal output from the threshold value generating circuit 1104C, and outputs the comparison result (the waveform (c) of FIG. 20). The level of the threshold value signal generated by the threshold value generating circuit 1104C is normally set to a level that intersects the signal pattern of the preamble portion of the received burst cell.

The output signal from the comparator 1104D is input as a set signal into the set terminal of the flip-flop circuit 1104E. The burst signal reset (the waveform (b) of FIG. 20) which serves as a reset signal that is input at a temporally earlier timing than the burst cell is input from the reset terminal 1111 into the reset terminal of the flip-flop circuit 1104E. As a result, the flip-flop circuit 1104E outputs a pulse signal that rises at the timing of the rise of the first pulse of the output signal from the comparator 1104D, and falls at the timing of the rise of the burst reset signal subsequently input from the reset terminal 1111 (the waveform (d) of FIG. 20).

Because the output signal from the comparator 1104D is used as a set signal in the flip-flop circuit 1104E in this manner, in the same way as in the data detection section 1104 shown in FIG. 9, the start point of the pulse of the output signal from the flip-flop circuit 1104E, which is the output signal from the data detection section 1104′″, is always identical to the second bit of the preamble portion.

As has been described above, in the optical burst signal receiving device of the second embodiment of the present invention, based on a voltage burst signal obtained from a signal that is created by photoelectrically converting a received optical burst signal, control is performed for each burst cell of the plurality of burst cells contained in the voltage burst signal such that the detection operation of the level detection of a burst cell, which is necessary in order for the gain and phase of an amplifier system to be controlled such that the level of each burst cell is substantially equal, is ended within a predetermined period which commences from the start point of the preamble portion of each burst cell. Accordingly, it becomes possible to limit the timing of switching the gain and phase in burst-by-burst AGC to a predetermined period commencing from the start point of the preamble portion of a burst cell. As a result of this, normal signal reproduction becomes possible without any bit errors being generated.

Moreover, by making it possible to set the timing of switching the gain in burst-by-burst AGC to within the leading end portion of the preamble portion of a burst cell, it is possible to reduce non-reproducible signal patterns in the preamble portion to a minimum, and achieve improved transmission efficiency.

Furthermore, in the optical burst signal receiving device of the present embodiment, by altering the delay time t_{d} by the delay circuit 1104F, it becomes possible to arbitrarily set a level detection block which is a predetermined period commencing from the start point of the preamble portion of a burst cell. Accordingly, it is possible to set an appropriate level detection block (namely, the number of bits that can be used in the optical burst signal receiving device) in accordance with Standards such as ITU-T or IEEE and with the type of CDR.

### INDUSTRIAL APPLICABILITY

According to the optical burst signal receiving device of the present invention, by controlling the detection times of level detections of burst cells for performing burst-by-burst-AGC, it becomes possible to limit the timing of switching the gain in burst-by-burst AGC to within a predetermined period commencing from the start point of the preamble portion of a burst cell. As a result of this, normal signal reproduction in which no bit errors are generated becomes possible.

1. An optical burst signal receiving device comprising:
a photoelectric conversion unit that photoelectrically converts an input optical burst signal into a current burst signal and outputs the current burst signal;
a transimpedance amplifier that converts the current burst signal output from the photoelectric conversion unit into a phase-inverted voltage burst signal;
an equalizing amplifier that performs equalizing amplification on the output signal from the transimpedance amplifier and then outputs the resulting signal;
a level detection circuit that detects the level of the output signal from the transimpedance amplifier; and
an automatic gain control circuit that controls at least one of the transimpedance amplifier and the equalizing amplifier such that the optimum gain is attained for the level of a burst cell detected by the level detection circuit, wherein
the level detection circuit has:
a monitor window generating unit that generates a monitor window signal that regulates a level detection block, which is a predetermined period commencing from the start point of a preamble portion of the burst cell;
a reference voltage generating circuit that generates a reference voltage signal;
a threshold value comparator that compares the level of the output signal from the transimpedance amplifier with the level of the reference voltage signal; and
an AND circuit that performs an AND operation on the monitor window signal output from the monitor window generating unit and the output from the threshold value comparator.

2. The optical burst signal receiving device according to claim 1, wherein
the monitor window generating unit has:
a comparator that compares the level of the output signal from the transimpedance amplifier with the level of a monitor window threshold value signal which provides a reference that is used to generate the monitor window signal;
a flip-flop circuit that operates using the output from the comparator as a set signal, and using a burst signal reset that is output at a temporally earlier timing than the burst cell as a reset signal;
a rise detection circuit that outputs a pulse signal at the timing when an output signal from the flip-flop circuit rises; and
a pulse width extension circuit that outputs as the monitor window signal a signal obtained by extending the pulse width of the pulse signal output from the rise detection circuit by the block of the monitor window that regulates the level detection block of the burst cell, and
the difference between the level of the monitor window threshold value signal and the level of the output signal from the transimpedance amplifier at the time when the burst cell is not input, is smaller than the difference between the level of the reference voltage signal and the level of the output signal from the transimpedance amplifier at the time when the burst cell is not input.

3. An optical burst signal receiving device for a PON communication system that photoelectrically converts an input optical burst signal into a current burst signal and outputs the current burst signal, converts the current burst signal into a phase-inverted voltage burst signal, detects the level of a burst cell for each one of a plurality of burst cells contained in the voltage burst signal, and, based on the detection results, controls at least one of the gain and phase of an amplifier system such that the levels of the plurality of burst cells are substantially equal, wherein
the optical burst signal receiving device comprises a control unit that, based on the voltage burst signal, performs control for each one of the plurality of burst cells contained in the voltage burst signal such that the level detection operation is ended within a predetermined period commencing from the start point of a preamble portion of the burst cell.

4. An optical burst signal receiving device comprising:
a photoelectric conversion unit that photoelectrically converts an input optical burst signal into a current burst signal and outputs the current burst signal;
a transimpedance amplifier that converts the current burst signal output from the photoelectric conversion unit into a phase-inverted voltage burst signal;
an equalizing amplifier that performs equalizing amplification on the output signal from the transimpedance amplifier and then outputs the resulting signal;
a level detection circuit that detects the level of the output signal from the transimpedance amplifier; and
an automatic gain control circuit that controls at least one of the transimpedance amplifier and the equalizing amplifier such that the optimum gain is attained for the level of a burst cell detected by the level detection circuit, wherein
the level detection circuit has a control unit that, based on the output from the transimpedance amplifier, performs control for each one of a plurality of burst cells contained in the voltage burst signal such that the level detection operation by the level detection circuit is ended within a predetermined period commencing from the start point of a preamble portion of the burst cell.

5. The optical burst signal receiving device according to claim 4, wherein the control unit has:
a peak hold circuit that holds a peak value of a normal phase signal of the voltage burst signal output from the transimpedance amplifier;
a differential amplifier that outputs an amplified signal of a difference between the normal phase signal of the voltage burst signal and an output signal from the peak hold circuit;
a comparator that compares the level of the output signal from the differential amplifier with the level of a predetermined threshold value; and
a flip-flop circuit that operates using an output signal from the comparator as a set signal, and using a burst signal reset that is input at a temporally earlier timing than the burst cell as a reset signal.

6. The optical burst signal receiving device according to claim 4, wherein the control unit has:
a peak hold circuit that holds a peak value of a normal phase signal of the voltage burst signal output from the transimpedance amplifier;
a differential amplifier that outputs an amplified signal of a difference between the normal phase signal of the voltage burst signal and an output signal from the peak hold circuit;
a comparator that compares the level of the output signal from the differential amplifier with the level of a predetermined threshold value;
a flip-flop circuit that operates using an output signal from the comparator as a set signal, and using a burst signal reset that is output at a temporally earlier timing than the burst cell as a reset signal; and
a delay circuit that delays an output signal from the flip-flop circuit by a predetermined time.

7. The optical burst signal receiving device according to claim 4, wherein the control unit has:
a peak hold circuit that holds a peak value of a normal phase signal of the voltage burst signal output from the transimpedance amplifier;
a differential amplifier that outputs an amplified signal of a difference between the normal phase signal of the voltage burst signal and an output signal from the peak hold circuit;
a comparator that compares the level of the output signal from the differential amplifier with the level of a predetermined threshold value;
a delay circuit that delays an output signal from the comparator by a predetermined time; and
a flip-flop circuit that operates using an output signal from the delay circuit as a set signal, and using a burst signal reset that is input at a temporally earlier timing than the burst cell as a reset signal.

8. The optical burst signal receiving device according to claim 2, wherein
the threshold value comparator of the level detection circuit compares the level of a normal phase signal obtained by performing phase inversion on the output signal from the transimpedance amplifier with the level of the reference voltage signal;
the comparator of the monitor window generating unit compares the level of the normal phase signal obtained by performing phase inversion on the output signal from the transimpedance amplifier with the level of the monitor window threshold value signal; and
the level of the monitor window threshold value signal is lower than the level of the reference voltage signal.
